(19) United States
(12) Patent Application Publication
(10) Pub. No.: US 2025/0142241 A1
(43) Pub. Date: May 1, 2025

(54) WAKEUP MECHANISM FOR AN AUDIO SYSTEM

(71) Applicant: TEXAS INSTRUMENTS INCORPORATED, Dallas, TX (US)

(72) Inventors: Udit Rawat, Allen, TX (US); Bichoy Bahr, Allen, TX (US); Baher Haroun, Allen, TX (US)

(21) Appl. No.: 18/495,675

(22) Filed: Oct. 26, 2023

(51) Int. Cl. H04R 1/08

(52) U.S. Cl. CPC H04R 1/08

(57) ABSTRACT

An acoustic device is provided which comprises an audio system including: a microphone having a microphone output, and a processing circuit having a wakeup input, an audio input, and an audio output, the audio input coupled to the microphone output. In at least one example, the acoustic device further comprises an acoustic sensor separate from the microphone, the acoustic sensor having a sensor output. In at least one example, the acoustic device further comprises a wakeup circuit having a sensor input and a wakeup output, the sensor input coupled to the sensor output, wherein the wakeup output is coupled to the wakeup input.

### BACKGROUND

A transducer can convert between mechanical energy (e.g., vibration) and electrical energy. A speaker of an audio device is one such example of a transducer and may include a membrane that can vibrate to generate audible sound waves or acoustic signal responding to an audio signal. An audio device such as a microphone can also include a flap (e.g., a piezoelectric flap) that can vibrate in response to external sound waves and generate electrical signals representing the sound waves. The electrical signals can then be further processed, for example, to generate an audio signal or to extract other information. During periods of inactivity of the audio device, the audio device may be placed in a low power state or turned off. Waking up the audio device may be challenging.

### BRIEF DESCRIPTION OF DRAWINGS

The examples will be understood more fully from the detailed description given below and from the accompanying drawings, which, however, should not be taken to limit the disclosure to the specific examples, but are for explanation and understanding only.

FIG. 1A is a schematic illustrating a system with a wakeup device and audio system, according to at least one example.

FIG. 1B is a schematic illustrating a wakeup signal generation circuit, accordance at least one example.

FIG. 2 is a schematic illustrating a cross-section of an audio device including an audio system and a portion of the wakeup device, according to at least one example.

FIG. 3 is a schematic illustrating a cross-section of a portion of an audio device having a microphone and processing circuitry, according to at least one example.

FIG. 4 is a schematic illustrating an audio system with an array of acoustic sensors of the wakeup device coupled to a processing circuitry, according to at least one example.

FIG. 5 is a schematic illustrating an audio system with an array of acoustic sensors of the wakeup device coupled to a processing circuitry, according to at least one example.

FIG. 6 is a schematic illustrating an audio system with an array of acoustic sensors of the wakeup device coupled to a processing circuitry, according to at least one example.

FIG. 7A is a schematic illustrating an audio system with an array of acoustic sensors and associated weighting circuit, according to at least one example.

FIG. 7B is a schematic illustrating an apparatus with a weighting circuitry, according to at least one example.

FIG. 7C is a schematic illustrating a weighting circuitry, according to at least one example.

FIG. 7D is a schematic illustrating a set of binary weighted transistors representing a transistor of the weighting circuitry, according to at least one example.

FIG. 8A is a schematic illustrating an array of acoustic sensors based on cantilevers, according to at least one example.

FIG. 8B is a schematic illustrating a zoomed section of cantilevers of the array of acoustic sensors, according to at least one example.

FIG. 8C is a schematic illustrating a circuit model of the array of acoustic sensors, according to at least one example.

FIG. 8D includes graphs showing sensitivity of two acoustic sensors with respect to frequency, according to at least one example.

FIG. 9 is a schematic illustrating electrical coupling of individual acoustic sensors of an array of acoustic sensors, according to at least one example.

FIG. 10 is a schematic illustrating a backside of an array of acoustic sensors over trusses of a substrate, according to at least one example.

FIGS. 11A, 11B, 11C, and 11D are schematics illustrating cross-sections of piezoelectric bimorph cantilevers of a wakeup device, according to some examples.

FIG. 12 is a schematic illustrating a wakeup device coupled to a processing circuitry, according to at least one example.

FIG. 13 is a schematic illustrating a circuit model of an array of cantilever sensors, according to at least one example.

FIG. 14 includes a graph showing sensitivity of a cantilever sensor with respect to frequency, according to at least one example.

FIG. 15 illustrates a wakeup device including a capacitive sensor, according to at least one example.

FIG. 16 illustrates a method of waking a microphone by an acoustic sensor, according to at least one example.

### SUMMARY

In at least one example, an acoustic device is provided which comprises an audio system including a microphone having a microphone output, and a processing circuit having a wakeup input, an audio input, and an audio output, wherein the audio input is coupled to the microphone output. In at least one example, the acoustic device further comprises an acoustic sensor separate from the microphone, wherein the acoustic sensor has a sensor output. In at least one example, the acoustic device comprises a wakeup circuit having a sensor input and a wakeup output, wherein the sensor input is coupled to the sensor output, and wherein the wakeup output is coupled to the wakeup input.

In at least one example, a method is provided which comprises receiving an acoustic signal by an acoustic sensor separate from a microphone. In at least one example, the method further comprises generating a wakeup signal for an audio system including the microphone and a processing circuit based on at least one of an amplitude or a frequency of the acoustic signal. In at least one example, the method further comprises providing the wakeup signal to the audio system to cause the processing circuit to transition from a first mode to a second mode.

In at least one example, an apparatus is provided which comprises an acoustic sensor having a sensor output, wherein the acoustic sensor has a resonant frequency at or below 4 kHz. In at least one example, the apparatus further comprises a wakeup circuit having a sensor input and a wakeup output, wherein the sensor input is coupled to the sensor output.

In at least one example, an apparatus is provided which comprises a circuitry having a wakeup output for a microphone based at least on detection of an audio by an acoustic sensor, wherein the acoustic sensor comprises a piezoelectric cantilever having a resonant frequency at or below 4 KHz.

In at least one example, a method is provided which comprises receiving a first audio of a first frequency. In at least one example, the method further comprises generating a wakeup indication for a microphone based on detection of the first audio by an acoustic sensor. In at least one example, the method further comprises waking up the microphone based on the wakeup indication, wherein the acoustic sensor comprises a piezoelectric cantilever having a resonant frequency at or below 4 kHz.

In at least one example, an acoustic transducer device is provided which comprises a microphone to detect a first audio. In at least one example, the acoustic transducer device further comprises a sensor to detect a second audio. In at least one example, the acoustic transducer device further comprises a circuitry coupled to the microphone and the sensor, wherein the circuitry is operable to generate a wakeup indication for the microphone based on detection of the second audio by the sensor.

### DETAILED DESCRIPTION

Disclosed herein are one or more mechanisms to wake up an audio system from a low power state or from an off state to an operational state or an on state. In at least one example, an audio device comprises an audio system which includes a microphone having a microphone output, and a processing circuit having a wakeup input, an audio input, and an audio output. In at least one example, the audio input is coupled to the microphone output. In at least one example, the microphone is a micro-electromechanical system (MEMS) or nano-electromechanical system (NEMS) that is configured to convert mechanical energy from incident sound waves or output on the audio input to an electrical output on the microphone output. In at least one example, the microphone comprises a piezoelectric flap including electrodes. In at least one example, the piezoelectric flap can vibrate responsive to external sound waves and generate electrical signals representing the sound waves. In at least one example, the piezoelectric flap may have a frequency response that peaks at a particular resonance frequency. In at least one example, the frequency response dictates how the piezoelectric flap converts between sound waves and audio signals across different frequencies. In at least one example, the resonant frequency can be based on a particular frequency of interest to improve separation of the desired audio signal and noise. In at least one example, the overall frequency response of a piezoelectric flap, including its resonant frequency, may be tuned at least initially by selecting the correct materials and dimensions. In at least one example, the overall frequency response of the piezoelectric flap is tuned to capture human generated audio. In at least one example, no audio is being received by the microphone, a power management circuitry turns off the audio system to save power.

In at least one example, the audio device further comprises an acoustic sensor separate from the microphone, the acoustic sensor having a sensor output. In at least one example, the acoustic sensor is a piezoelectric based cantilever or an array of cantilevers. In at least one example, the acoustic sensor is a capacitive sensor. In at least one example, the piezoelectric based cantilever or an array of cantilevers have a frequency response different from the frequency response of the microphone. In at least one example, the piezoelectric based cantilever or an array of cantilevers has a resonant frequency (e.g., less than 4 kHz) lower than the resonant frequency of the microphone. In at least one example, the piezoelectric based cantilever or an array of cantilevers have higher sensitivity to audio than the microphone. In at least one example, the piezoelectric based cantilever or an array of cantilevers sense a targeted frequency range of an audio which is typically used to start a conversation (e.g., Hey Siri®, Hey Alexa®, etc.).

In at least one example, the audio device further comprises a wakeup circuit having a sensor input and a wakeup output. In at least one example, the sensor input coupled to the sensor output. In at least one example, the wakeup output is coupled to the wakeup input. In at least one example, the wakeup circuit receives output from the acoustic sensor (e.g., the piezoelectric based cantilever or an array of cantilevers) and wakes up the audio system based on the output from the acoustic sensor. In at least one example, the wakeup circuit turns on power for the microphone and processing circuit of the audio system. In at least one example, the more sensitive (e.g., sensitive to sensing audio) acoustic sensor senses audio of a first frequency and then notifies the wakeup circuit about the sensed audio. In at least one example, the wakeup circuit then wakes up the less sensitive audio system to sense audio of a second frequency different from the first frequency.

In at least one example, the microphone and the acoustic sensor are fabricated on the same die. In at least one example, the microphone and the acoustic sensor are fabricated on different dies. In at least one example, the microphone and the acoustic sensor are fabricated using the same fabrication process. In at least one example, the microphone and the acoustic sensor share the same back volume. A shared back volume may result in interference between the audio system and the acoustic sensor. In at least one example, the audio device includes a clamping mechanism to clamp or park the acoustic sensor after the wakeup circuit wakes up the audio system.

There are many technical effects of various examples discussed herein. For example, an audio device may have lower power consumption by integrating or using a wakeup device of at least one example where a power management circuitry powers down an audio system after a programmable or predetermined time when no audio is received. In at least one example, the wakeup device including acoustic sensors (e.g., active or passive sensors) can sense low frequency audio with higher sensitivity than the audio system and wakes up or powers up the audio system based on the sensed low frequency audio. By decoupling the wakeup device from the audio system, the resonant frequency of the wakeup device (e.g., resonant frequency of the piezoelectric cantilever) is turned to sense a particular audio frequency or frequency range different from the resonant frequency of the audio system. The audio system can thus be independently designed from the wakeup device which allows for design and manufacturing flexibility. In at least one example, the wakeup device clamps or parks the acoustic sensor to mitigate any interference from wakeup device to the audio system after the audio system is woken up. Other technical effects will be evident from various examples described herein.

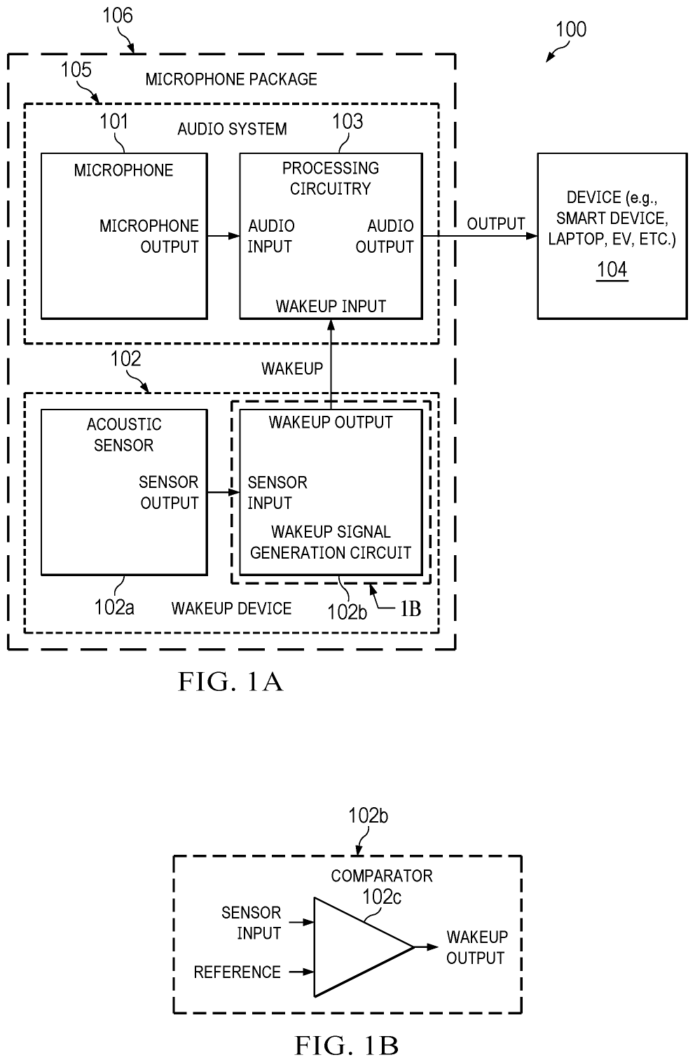

FIG. 1A is a schematic illustrating a system 100 with a wakeup device and audio system, according to at least one example. In at least one example, system 100 comprises microphone 101, wakeup device 102, processing circuitry 103, and device 104. In at least one example, microphone 101 and processing circuitry 103 are part of an audio system 105. In at least one example, wakeup device 102 includes an acoustic sensor 102a and wakeup signal generation circuit 102b.

In at least one example, microphone 101 comprises a micro-electromechanical system (MEMS) or a nano-electromechanical system (NEMS) that converts mechanical energy from incident sound waves. In at least one example, microphone 101 outputs an analog electrical signal on a microphone output to an audio input of processing circuitry 103. In at least one example, microphone 101 comprises a piezoelectric flap including electrodes. In at least one example, the piezoelectric flap vibrates responsive to external sound waves and generates electrical signals representing the sound waves. In at least one example, the output from the piezoelectric flap of microphone 101 couples to the microphone output. In at least one example, the microphone output couples to an audio input of processing circuitry 103. In at least one example, an audio output couples to device 104 and provides a processed audio output (e.g., digital signal representing audio sensed by microphone 101) to device 104. In at least one example, device 104 is any suitable client that uses the audio output from audio system 105. Examples of device 104 include a smart device, a smart phone, a tablet, an electric vehicle, a wearable device, a computer, etc.

In at least one example, processing circuitry 103 comprises (or is part of) an integrated circuit which includes logic and or circuitry to convert the audio input in analog or acoustic domain (e.g., an analog signal) to the audio output in digital domain or electrical domain (e.g., digital signal). In at least one example, processing circuitry 103 includes a power management circuitry that turns off microphone 101 (e.g., by disconnecting its power supply or gating its power supply) during a low power (or sleep) mode or upon detecting a programmable or predetermined period of inactivity (e.g., when no sound is sensed by microphone 101). In at least one example, processing circuitry 103 lowers power consumption of microphone 101 (e.g., by lowering voltage for its power supply) during a low power (or sleep) mode or upon detecting a programmable or predetermined period of inactivity (e.g., when no sound is sensed by microphone 101). In at least one example, processing circuitry 103 turns off microphone 101 and some or all circuits of processing circuitry 103 (e.g., by disconnecting their power supply or gating their power supply) during a low power (or sleep) mode or upon detecting a programmable or predetermined period of inactivity (e.g., when no sound is sensed by microphone 101). In at least one example, processing circuitry 103 lowers power consumption of microphone 101 and some or all circuits of processing circuitry 103 (e.g., by lowering voltage for their power supply) during a low power (or sleep) mode or after a programmable or predetermined period of inactivity (e.g., when no sound is sensed by microphone 101).

In at least one example, processing circuitry 103 is configured to enter a first mode responsive to the wakeup input in a first state, and to enter a second mode responsive to the wakeup input in a second state. In at least one example, the first mode is the aforementioned low power (or sleep) mode, and the first state indicates that acoustic sensor 102a has not sensed an audio. In at least one example, processing circuitry 103 is disabled in the first mode. In at least one example, the second mode is an active state, and the second state indicates that acoustic sensor 102a sensed an audio. In at least one example, processing circuitry 103 samples an audio signal at the audio input at a first rate in the first mode. In at least one example, processing circuitry 103 samples the audio signal at the audio input at a second rate in the second mode. In at least one example, the first rate is lower than the second rate.

FIG. 1B is a schematic illustrating a wakeup signal generation circuit 102b, accordance at least one example. In at least one example, wakeup signal generation circuit 102b includes comparator 102c having a first comparator input, a reference input, and a comparator output. In at least one example, the first comparator input couples to the sensor input, and the comparator output couples to the wakeup output. Referring to FIG. 1A, in at least one example, processing circuitry 103 includes an analog-to-digital converter (ADC) and a digital signal processor (DSP). In at least one example, the ADC has an ADC input and an ADC output. In at least one example, the DSP has a DSP input and a DSP output. In at least one example, the ADC input couples to the audio input. In at least one example, the DSP input couples to the ADC output. In at least one example, the DSP output couples to the audio output. In at least one example, at least one of the ADC or the DSP has the wakeup input.

In at least one example, processing circuitry 103 receives, at its wakeup input, a wakeup signal from wakeup device 102. In at least one example, processing circuitry 103 receives the wakeup signal at its wakeup input and turns on power for microphone 101. In at least one example, processing circuitry 103 receives the wakeup signal at its wakeup input and turns on power for microphone 101 and powers up logic and circuits of processing circuitry 103.

In at least one example, acoustic sensor 102a has a sensor output which couples to sensor input of wakeup signal generation circuit 102b. In at least one example, wakeup output of wakeup circuit couples to wakeup input of processing circuitry 103. In at least one example, acoustic sensor 102a includes a piezoelectric cantilever sensor or a capacitive sensor. In at least one example, acoustic sensor 102a includes a plurality of sensor units, a plurality of sensor unit outputs, and a plurality of sensor unit inputs. In at least one example, each plurality of sensor units has a sensor unit output. In at least one example, the plurality of sensor unit outputs is part of the sensor output. In at least one example, the sensor input includes the plurality of sensor unit inputs. In at least one example, each sensor unit input of the plurality of sensor unit inputs couples to a respective one of the plurality of sensor unit outputs.

In at least one example, the plurality of sensor units includes a first sensor unit having a first resonant frequency, and a second sensor unit having a second resonant frequency. In at least one example, the first resonant frequency is different from the second resonant frequency. In at least one example, the plurality of sensor units includes a first sensor unit having a first sensor surface (S1) having a first dimension (L1). In at least one example, the plurality of sensor units includes a second sensor unit having a second sensor surface (S2) having a second dimension (L1) different from the first dimension. In at least one example, the plurality of sensor units includes a first sensor unit having a first piezoelectric bimorph flap with a first bimorph structure. In at least one example, the plurality of sensor units includes a second sensor unit having a second piezoelectric bimorph flap with a second bimorph structure different from the first bimorph structure.

In at least one example, wakeup signal generation circuit 102b includes a weight and summation circuitry having a plurality of weighing inputs and a summation output. In at least one example, each of the plurality of weighing inputs couples to a respective one of the plurality of sensor unit outputs, and the summation output couples to the wakeup output. In at least one example, wakeup signal generation circuit 102b includes memory to store the plurality of weighing inputs. In at least one example, each weighting input changes the corresponding output of the associated sensor unit output. In at least one example, each weighting input adds or subtracts to the associated sensor unit output to modify its output. In at least one example, wakeup signal generation circuit 102b receives the modified output. In at least one example, the modified output constructively or effectively changes amplitude of the associated sensor unit output, and thus the sensitivity of the associated sensor unit to a received audio. In at least one example, wakeup signal generation circuit 102b is integrated in processing circuitry 103.

In at least one example, microphone 101 (of audio system 105) and acoustic sensor 102a have different frequency responses. In at least one example, microphone 101 of audio system 105 has a first sensitivity within a frequency range. In at least one example, acoustic sensor 102a has a second sensitivity within the frequency range. In at least one example, the second sensitivity is higher than the first sensitivity. In at least one example, microphone 101 has a first resonant frequency. In at least one example, acoustic sensor 102a has a second resonant frequency. In at least one example, the second resonant frequency is lower than the first resonant frequency. In at least one example, the second resonant frequency is within the frequency range. In at least one example, the second resonant frequency is below 4 kHz.

In at least one example, acoustic sensor 102a has a control input. In at least one example, wakeup signal generation circuit 102b has a control output coupled to the control input. In at least one example, wakeup signal generation circuit 102b provides a disable signal at the control output to lower power of acoustic sensor 102a when processing circuitry 103 and microphone 101 are powered on or in active state and after the wakeup output is set to the second state. In at least one example, acoustic sensor 102a has a sensor surface. In at least one example, acoustic sensor 102a clamps the sensor surface at a particular position responsive to the disable signal to mitigate acoustic interference with microphone 101, in a case where microphone 101 and acoustic sensor 102a share the same back volume.

In at least one example, audio system 105 and wakeup device 102 are co-located in microphone package 106 (or case). In at least one example, microphone package 106 encloses microphone 101, acoustic sensor 102a, and a back volume space that surrounds microphone 101 and acoustic sensor 102a. In at least one example, microphone package 106 comprises a first audio port and a second audio port. In at least one example, microphone 101 couples to the first audio port. In at least one example, acoustic sensor 102a couples to the second audio port. In at least one example, microphone 101 and acoustic sensor 102a are on the same die. In at least one example, wakeup device 102 and audio system 105 are on a same die. In at least one example, wakeup device 102 and audio system 105 are on separate dies.

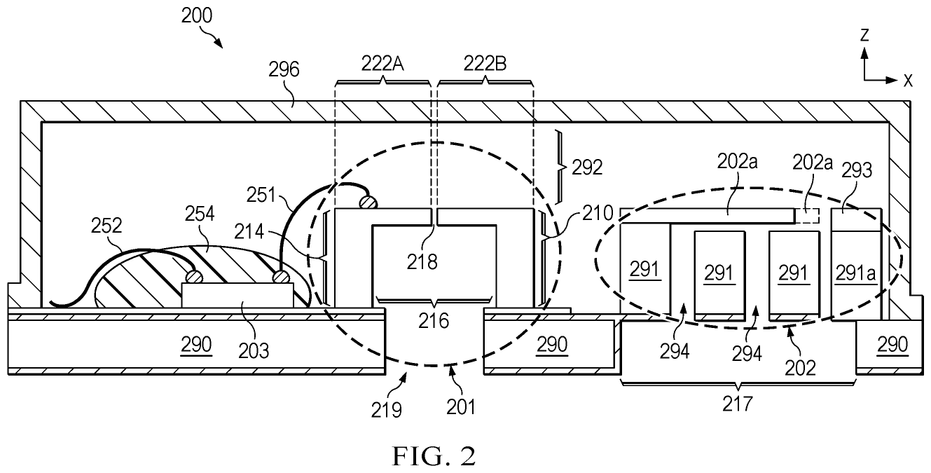

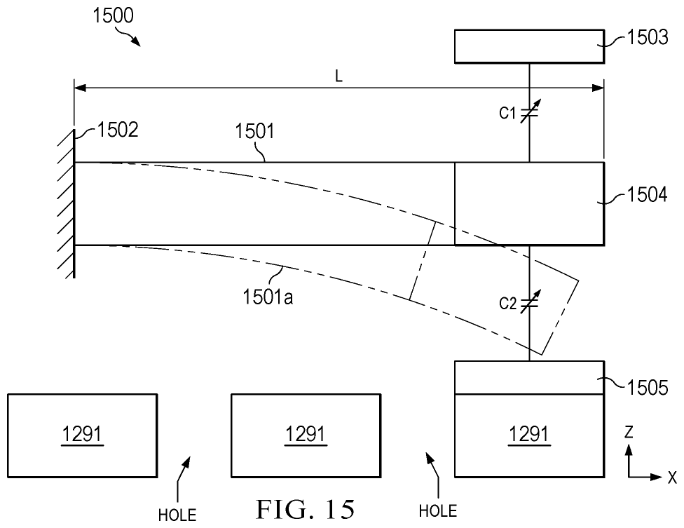

FIG. 2 is a schematic illustrating a cross-section of an audio device 200 including an audio system (e.g., audio system 105) and a portion of wakeup device 102, according to at least one example. In at least one example, audio device 200 includes microphone 201 and wakeup device 202 on substrate 290. Microphone 201 includes piezoelectric cantilever system 210 on semiconductor structure 214, openings 216 and 219, and slit or gap 218. In at least one example, piezoelectric cantilever system 210 includes piezoelectric flaps 222A and 222B. In at least one example, audio device 200 further includes an integrated circuit 203 encapsulated in epoxy 254, and bond wires 252 electrically coupled between integrated circuit 203 and microphone 201 and wakeup device 202. In at least one example, audio device 200 further includes a case or package 296 that encloses integrated circuit 203, piezoelectric cantilever system 210 (of microphone 201), piezoelectric cantilever 202a (of wakeup device 202), and back volume space 292. In at least one example, microphone 201 comprises one or more capacitive sensors such as one described with reference to FIG. 15 instead of or in addition to cantilever system 210 having piezoelectric flaps 222A and 222B.

In at least one example, audio device 200 is configured as a microphone. In at least one example, audio device 200 is configured as a speaker. In at least one example, audio device 200 is a packaged device including piezoelectric cantilever system 210 and integrated circuit 203 on a substrate 290. In at least one example, substrate 290 is a package substrate, a printed circuit board (PCB), etc. In at least one example, substrate 290 comprises silicon oxide (SiO₂) or any other suitable material.

In at least one example, piezoelectric cantilever system 210 includes piezoelectric flaps 222A and 222B. In at least one example, a membrane of each piezoelectric flap 222A and 222B has one end coupled to semiconductor structure 214 having opening 216, and the other end of each flap can move up and down as a cantilever or flap over opening 216. In at least one example, slit or gap 218 separates piezoelectric flaps 222A and 222B. In at least one example, slit or gap 218 allows each flap to move independently with respect to each other in certain operations. In at least one example, integrated circuit 203 addresses or controls each piezoelectric flap of piezoelectric cantilever system 210 individually. In at least one example, integrated circuit 203 operates each piezoelectric flap 222A and 222B as a sensor (e.g., as part of a microphone to detect and convert sound waves into an electrical signal) or as an actuator (e.g., as a speaker to generate sound waves, or otherwise to move the flap).

In at least one example, piezoelectric cantilever system 210 is a MEMS or a NEMS, in which the flaps are fabricated within micron or nanometer dimensions, respectively. Certain MEMS or NEMS technologies may provide several benefits, such as batch fabrication that may lower manufacturing costs, small feature sizes, high resonant frequencies, and improved impedance matching.

In at least one example, an interconnect (e.g., bond wire 251) communicatively couples integrated circuit 203 to piezoelectric cantilever system 210. In at least one example, epoxy 254 encapsulates integrated circuit 203. In at least one example, piezoelectric cantilever system 210 and integrated circuit 203 are on separate dies. In at least one example, piezoelectric cantilever system 210 and integrated circuit 203 are on the same die.

In at least one example, substrate 290 also includes opening 219 that joins opening 216 and exposes piezoelectric flaps 222A and 222B to the exterior of audio device 200. In at least one example, openings 216 and 219 define a front volume space (or an audio port). In at least one example, when integrated circuit 203 operates piezoelectric flaps 222A and 222B as part of a microphone, piezoelectric flaps 222A and 222B detect sound waves that propagate from the exterior of audio device 200 via the front volume space defined by opening 216 and generate electrical signals responsive to the detection of the sound waves. In at least one example, from the electrical signals, integrated circuit 203 extracts various properties of piezoelectric flaps 222A and 222B (e.g., frequency response, resonant frequency, etc.).

In at least one example, audio device 200 also includes case or package 296 mounted on substrate 290. In at least one example, case or package 296 covers cantilever 202a, piezoelectric cantilever system 210, integrated circuit 203, bond wire 251, epoxy 254. In at least one example, case or package 296 is made of any suitable material, such as metal, plastic, etc., to shield cantilever 202a, piezoelectric cantilever system 210, and integrated circuit 203 from noise and mechanical stress. In at least one example, case or package 296 defines a back volume space 292 in which piezoelectric flaps 222A and 222B of piezoelectric cantilever system 210 and cantilever 202a can move (e.g., vibrate). In at least one example, air fills back volume space 292.

In at least one example, slit or gap 218 allows air to flow between back volume space 292 and front volume space (defined by opening 216) to equalize the air pressure on two sides of piezoelectric flaps 222A and 222B. In at least one example, slit or gap 218 allows air to flow between back volume space 292 and front volume space (defined by opening 216) to prevent stress which may otherwise rupture or reduce the sensitivity of piezoelectric flaps 222A and 222B in operating as a microphone. In at least one example, slit or gap 218 is narrow to prevent the sound waves from reaching back volume space 292, and sets the lower cut-off frequency of the microphone.

In at least one example, a control circuit (e.g., wakeup signal generation circuit 102b) clamps or parks cantilever 202a after waking up processing circuitry (e.g., processing circuitry 103) of microphone 201. In at least one example, wakeup signal generation circuit 102b can apply a DC voltage between an electrode of cantilever 202a and substrate 290 to clamp/park cantilever 202a, and remove the DC voltage to unclamp/unpark cantilever 202a before waking up the processing circuitry of microphone 201. In at least one example, cantilever 202a is clampable. In at least one example, cantilever 202a senses audio which is used to wakeup microphone 201. While audio device 200 shows cantilever 202a, an array of cantilevers may be positioned adjacent to or around microphone 201, where each cantilever is configured (e.g., by its length, width, and/or material) to resonate at a particular frequency to sense low frequency audio, which is then used to wakeup microphone 201. In at least one example, cantilever 202a (also referred to as resonant cantilever) can be used to turn on any acoustic device, be it microphone or speaker.

In at least one example, cantilever 202a can rest on portions of substrate 291 that are separated by air gaps. These portions of substrate 291 are trusses with holes 294 between them. In at least one example, audio sensed by cantilever 202a interacts with cantilever 202a via holes between portions of substrate 291. In at least one example, cantilever 202a of wakeup device 202 are at a same level or plane as cantilever flaps of microphone 201. In at least one example, opening 217 is made in substrate 290 to provide air or fluid interaction with cantilever 202a through holes between substrate 291. In at least one example, a barrier or dam comprising substrate 291a and material 293 is formed after cantilever 202a end. The dam is deposited along a periphery of cantilever 202a and is made of a material thick enough so that when cantilever 202a curls due to residual stress, the vent gap between substrate 291 and substrate 291a is not enlarged significantly.

In at least one example, substrate 291a comprises the same material as substrate 290. In at least one example, material 293 includes one or more metal, polymer, or any other suitable material that can prevent formation of extra vent or opening as flaps of cantilever 202a move. In at least one example, flaps 202a moves against the barrier or dam (e.g., a fixed wall) comprising substrate 291a and material 293.

In at least one example, wakeup signal generation circuit 102b of FIG. 1A is incorporated in integrated circuit 203. In at least one example, wakeup signal generation circuit 102b of FIG. 1A is separate from integrated circuit 203 and is collocated within case or package 296 over substrate 290 and may have epoxy and wires like epoxy 254 and bond wire 251 and bond wire 252.

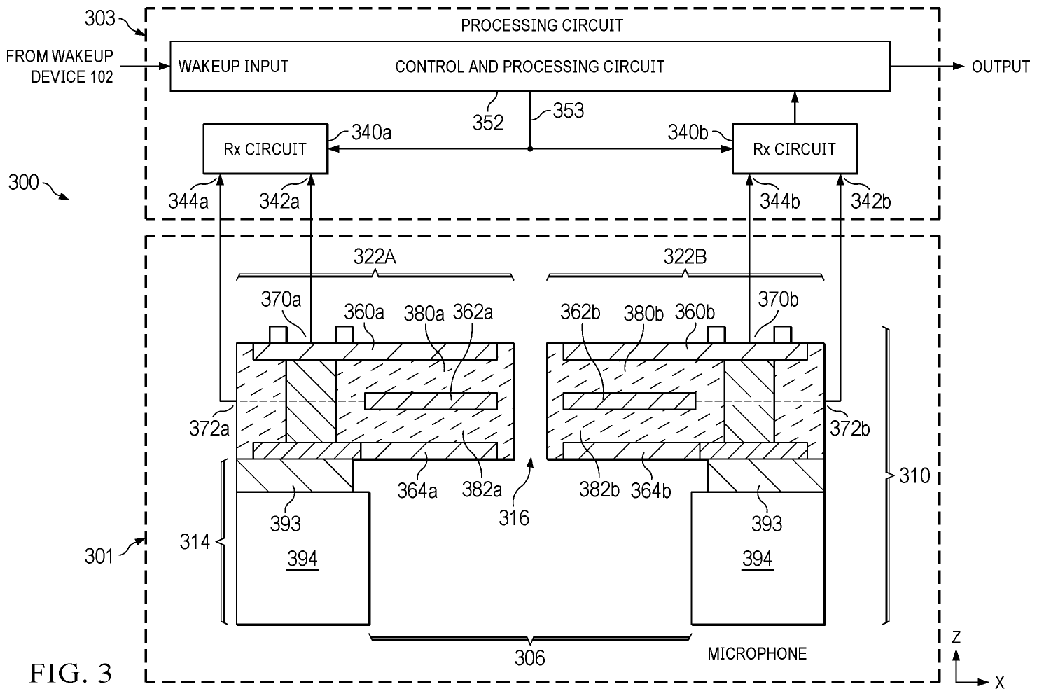

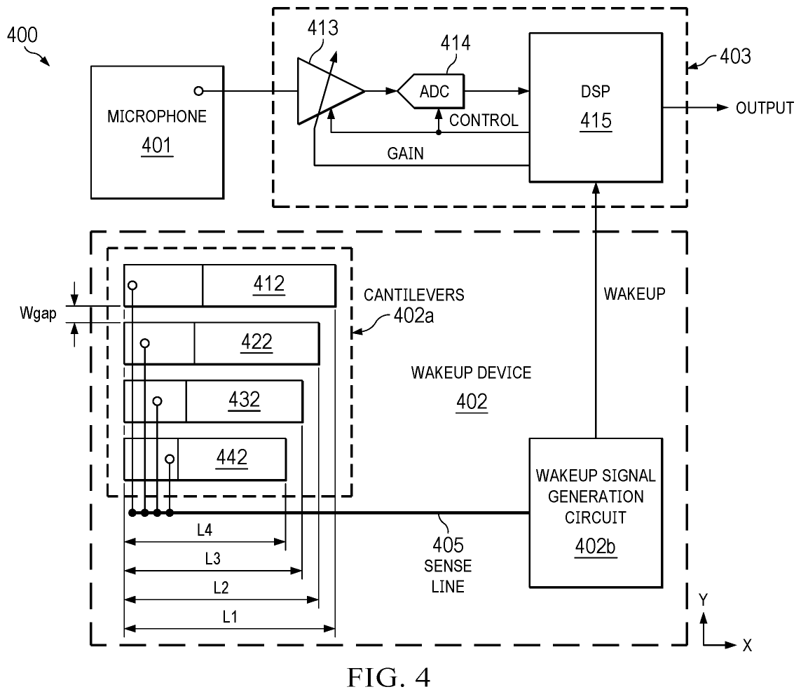

FIG. 3 is a schematic illustrating a cross-section of a portion 300 of audio device 200 having a microphone and processing circuitry, according to at least one example. In at least one example, portion 300 of audio device 200 comprises microphone 301 and processing circuitry 303. Microphone 301 can be an example of microphone 201 of FIG. 2 and microphone 101 of FIG. 1A. Processing circuitry 303 can be part of processing circuitry 103 of FIG. 1A and part of integrated circuit 203.

In at least one example, microphone 301 comprises piezoelectric cantilever system 310 that includes piezoelectric bimorph flaps 322A and 322B. In at least one example, gap or opening 316 separates piezoelectric bimorph flaps 322A and 322B. Each piezoelectric flap is a piezoelectric bimorph flap having a multi-layer structure. In at least one example, a bimorph flap has top electrode 360a, middle electrode 362a, bottom electrode 364a, and first piezoelectric layer 380a between top electrode 360a and middle electrode 362a. In at least one example, second piezoelectric layer 382a is between middle electrode 362a and bottom electrode 364a. Although the illustrated portion of piezoelectric cantilever system 310 shows two piezoelectric bimorph flaps 322A and 322B, piezoelectric cantilever system 310 may include any suitable number of piezoelectric bimorph flaps.

In at least one example, piezoelectric layer 380a has at least a portion between top electrode 360a and middle electrode 362a. In at least one example, piezoelectric layer 382a has at least a portion between middle electrode 362a and bottom electrode 364a. In at least one example, top electrode 360a and bottom electrode 364a couple to terminal 370a. In at least one example, middle electrode 362a couples to another terminal 372a.

In at least one example, bimorph flap 322B has top electrode 360b, middle electrode 362b, and bottom electrode 364b. In at least one example, a portion of middle electrode 362b is between top electrode 360b and bottom electrode 364b. In at least one example, piezoelectric bimorph flap 322B has at least two piezoelectric layers 380b and 382b. In at least one example, piezoelectric layer 380b has at least a portion between top electrode 360b and middle electrode 362b. In at least one example, piezoelectric layer 382b has at least a portion between middle electrode 362b and bottom electrode 364b. In at least one example, top electrode 360b and bottom electrode 364b couple to a terminal 372b. In at least one example, middle electrode 362b couples to another terminal 370b.

In at least one example, electrodes 360a and 360b, 362a and 362b, and 364a and 364b comprise one or more layers of any suitable conductive material(s). In at least one example, piezoelectric layers 380a and 380b, and 382a and 382b are formed of any suitable piezoelectric material(s). In at least one example, electrodes 360a and 364b and piezoelectric layers 380a and 382b comprise material(s) compatible with certain CMOS processing. In at least one example, electrodes 360a and 360b, and 362a and 362b comprise molybdenum (Mo or “moly”). In at least one example, piezoelectric layers 380a and 380b, and 382a and 382b comprise aluminum nitride (“AlN”). In at least one example, electrodes 360a and 360b, 362a and 362b, and 364a and 364b and piezoelectric layers 380a and 380b, and 382a and 382b include any suitable material to execute their expected functions.

In at least one example, terminals 370a, 372a, 370b, and 372b can include any suitable electrical connector to transfer electrical current. In at least one example, terminals 370a and 372a electrically couple piezoelectric bimorph flap 322A to receiver (Rx) circuit 340a. In at least one example, terminals 370b and 372b electrically couple piezoelectric bimorph flap 322B to Rx circuit 340b.

In at least one example, Rx circuit 340a includes circuitry that receives electrical signals at receiver inputs 342a and 344a. In at least one example, electrical signals at receiver inputs 342a and 344a represent an electric field between electrodes 360a, 362a, and 364a that reflect a stress in piezoelectric bimorph flap 322A due to the sound waves. In at least one example, Rx circuit 340a provides corresponding electrical signals to control and processing circuit 352. In at least one example, piezoelectric bimorph flap 322A vibrates responsive to soundwaves, resulting in stress that is converted into an electrical signal that is provided to Rx circuit 340a via inputs 342a and 344a. In at least one example, Rx circuit 340a performs a conversion operation on received electrical signals. In at least one example, Rx circuit 340a performs an analog-to-digital conversion that involves receiving analog electrical signals at receiver inputs 342a and 344a and converting the received analog electrical signals to digital electrical signals. Rx circuit 340a provides converted digital electrical signals to control and processing circuit 352. In at least one example, Rx circuit 340a provides analog signals to control and processing circuit 352. In at least one example, processing circuit 352 converts received analog circuits to digital signals using an internal analog-to-digital converter. In at least one example, control and processing circuit 352 provides an output to device 104.

In at least one example, Rx circuit 340b includes circuitry that receives electrical signals at receiver inputs 342b and 344b. In at least one example, electrical signals at receiver inputs 342b and 344b represent an electric field between electrodes 360b, 362b, and 364b that reflect a stress in piezoelectric bimorph flap 322B due to the sound waves. In at least one example, Rx circuit 340b provides corresponding electrical signals to control and processing circuit 352. In at least one example, piezoelectric bimorph flap 322B vibrates responsive to soundwaves, resulting in stress that is converted into an electrical signal that is provided to Rx circuit 340b via inputs 342b and 344b. In at least one example, Rx circuit 340b performs a conversion operation on received electrical signals. In at least one example, Rx circuit 340b performs an analog-to-digital conversion that involves receiving analog electrical signals at receiver inputs 342b and 344b and converting the received analog electrical signals to digital electrical signals. In at least one example, Rx circuit 340b provides converted digital electrical signals to control and processing circuit 352. In at least one example, Rx circuit 340b provides analog signals to control and processing circuit 352. In at least one example, processing circuit 352 converts received analog circuits to digital signals using an internal analog-to-digital converter. Control and processing circuit 352 provides an output to device 104. In at least one example, control and processing circuit 352 receives wakeup input from wakeup device 102, and applies the wakeup input to wake up one or more circuits of control and processing circuit 352 from low power mode (sleep mode) or from inactive or power off state.

In at least one example, control and processing circuit 352 includes circuitry capable of processing electrical signals from piezoelectric cantilever system 310 representing detection of sound waves, controlling a variety of operating modes of microphone 301, including low power (or sleep) mode and normal/active mode, and providing processing functions on electrical signals at terminals 370a/370b and 372a/372b representing detection of audio. In at least one example, control and processing circuit 352 is part of an application specific integrated circuit (ASIC) (e.g., integrated circuit 203). In at least one example, control and processing circuit 352 includes one or more physical processor devices executing instructions stored in non-transitory memory to perform the processing and control functions.

In at least one example, when being mechanically driven (e.g., by sound waves), for example, one or more of piezoelectric bimorph flaps 322A and 322B vibrate responsive to the sound waves, resulting in stress that is converted into an electrical signal that is provided to and received by control and processing circuit 352.

In at least one example, in a low power (or sleep) mode, control and processing circuit 352 can suspend the processing of the electrical signals, disconnect Rx circuits 340a/340b from power supply, or operate Rx circuits 340a/340b at a lower sampling rate. In at least one example, responsive to a wakeup signal 353 from wakeup device 102, control and processing circuit 352 can enter an active/normal mode and process the electrical signals, connect Rx circuits 340a/340b to power supply and/or operate Rx circuits 340a/340b at the normal sampling rate.

In at least one example, piezoelectric bimorph flaps 322A and 322B are formed on structure 314, which can include multiple layers forming a stack. In at least one example, structure 314 includes an oxide layer 393 and a substrate 394 (e.g., a silicon substrate). In at least one example, structure 314 includes opening 306 formed therethrough, which permits sound waves to be transmitted to or from piezoelectric bimorph flaps 322A and 322B through opening 306. In at least one example, piezoelectric bimorph flaps 322A and 322B are both cantilevered and each has at least a portion extending over respective portions of opening 306. In at least one example, piezoelectric bimorph flaps 322A and 322B separate back volume space 292 from opening 306.

FIGS. 4-6 illustrate various layout configurations for the cantilever arrays of a wakeup device, in accordance with various examples. In at least one example, arrangement for cantilevers may depend on front volume Helmholtz resonance placement away from an audio band. In at least one example, different layout configurations can be used for the resonant microphone array based on the type of coupling and area requirements. Some configuration of cantilevers may present different low frequency roll-off (LRRO). LFRO is the lower-3 dB cutoff point in a frequency response. In at least one example, if four cantilevers are located in separate areas then a dam or barrier such as dam comprising substrate 291a and material 293 is formed along periphery of each cantilever. In at least one example, if the cantilevers are positioned or arranged together then the dam or barrier such as dam comprising substrate 291a and material 293 is placed around a border encompassing the cantilevers. In at least one example, the cantilevers can face one another like flaps 222A and 222B of microphone 201.

FIG. 4 is a schematic illustrating an audio system 400 (or an audio device) with an array of acoustic sensors of the wakeup device coupled to a processing circuitry, according to at least one example. In at least one example, audio system 400 comprises microphone 401, wakeup device 402, and processing and control circuitry 403. In at least one example, microphone 401 is a piezoelectric microphone as discussed with reference to microphone 301 of FIG. 3, microphone 201 of FIG. 2, and microphone 101 of FIG. 1A. Processing and control circuitry 403 can be part of control and processing circuit 352 of FIG. 3 and processing circuitry 103 of FIG. 1A. Wakeup device 402 can be part of or an example of wakeup device 202 of FIG. 2 and wakeup device 102 of FIG. 1A.

In at least one example, wakeup device 402 comprises an array of cantilevers 402a, wakeup processing circuit 402b, and sense line 405 (e.g., an analog bus). Wakeup processing circuit 402b may be an ultra-low power circuit and may operate with a low voltage supply (e.g., below 1V). In at least one example, array of cantilevers 402a comprise a plurality of cantilevers (e.g., cantilevers 412, 422, 432, and 442). Cantilever 412 has length L1 along an x-direction. Cantilever 422 has length L2 along an x-direction, where length L2 is shorter than length L1. Cantilever 432 has length L3 along an x-direction, where length L3 is shorter than length L2. Cantilever 442 has length L4 along an x-direction, where length L4 is shorter than length L3. In at least one example, cantilevers 412, 422, 432, and 442 are separated from one another by gap Wgap. In at least one example, Wgap is selected or designed to decouple operation of microphone 101 from cantilevers 412, 422, 432, and 442. In at least one example, each cantilever has a different resonant frequency. In at least one example, the resonant frequency of the cantilevers is different from the resonant frequency of microphone 401. In at least one example, the resonant frequency of the cantilevers is lower than the resonant frequency of microphone 401. In at least one example, each cantilever comprises piezoelectric material.

In at least one example, vibration from cantilevers 412, 422, 432, and 442 is converted into electric signals at electrodes of cantilevers 412, 422, 432, and 442, and these electric signals are transferred to sense line 405. In at least one example, wakeup signal generation circuit 402b comprises a plurality of comparators where each comparator receives an output from a cantilever and a reference voltage. An output of each comparator shows whether an audio of a particular frequency was sensed by a cantilever coupled to that comparator. In at least one example, the outputs of the comparators are input to a logic OR gate, and an output of the logic OR gate generates the wakeup output which is received by processing and control circuitry 403.

In at least one example, processing and control circuitry 403 comprises amplifier 413, analog-to-digital converter (ADC) 414, and digital-signal-processor (DSP) 415. In at least one example, amplifier 413 receives an analog input from microphone 401. In at least one example, amplifier 413 amplifies the analog input and provides the amplified analog input to ADC 414. In at least one example, amplifier 413 is a low-noise amplifier. In at least one example, amplifier 413 is a single stage or multiple stage amplifier. In at least one example, a power management circuit turns off amplifier 412 or operates amplifier 413 in lower power mode via control signal when microphone 401 does not receive or sense any audio for a programmable or predetermined amount of time. In at least one example, amplifier 413 has a variable gain. In at least one example, DSP 415 is operable to modify the gain of amplifier 413 via the gain signal. In at least one example, by modifying the gain of amplifier 413, the sensitivity of amplifier 413 can be adjusted so that it can better amplifier analog input from microphone 401.

In at least one example, ADC 414 converts the amplified analog output from amplifier 413 into digital signal. In at least one example, DSP powers off ADC 414 or places ADC 414 in low power mode via control signal when microphone 401 does not receive or sense any audio for a programmable or predetermined amount of time. In at least one example, DSP 415 generates an output which is received by device 104, where the output is based on audio sensed by microphone 401.

In at least one example, DSP 415 receives the wakeup output from wakeup signal generation circuit 402b. In at least one example, DSP 415 determines whether to wake up (e.g., to enter the normal operating mode) based on a logic value of the wakeup output. In at least one example, if wakeup output is a logic 1, then it indicates that at least one of the cantilevers sensed an audio in a desired frequency band, and so DSP 415 wakes up other circuits of processing and control circuit 403. In at least one example, wakeup processing circuit 402b includes logic to clamp or park one or all cantilevers 402a after DSP 415 (or any suitable power management circuit) wakes other circuits of processing and control circuit 403.

In at least one example, cantilevers 412, 422, 432, and 442 are designed with different material and staking configurations in the transducer and mass loading regions to achieve different sensitivities. In at least one example, cantilevers can have different shapes to have different stress and sensitivities. In at least one example, any number of cantilevers can be used depending on the area target. In at least one example, cantilevers 412, 422, 432, and 442 of varying lengths can be electrically or mechanically coupled to get the designed filtering response.

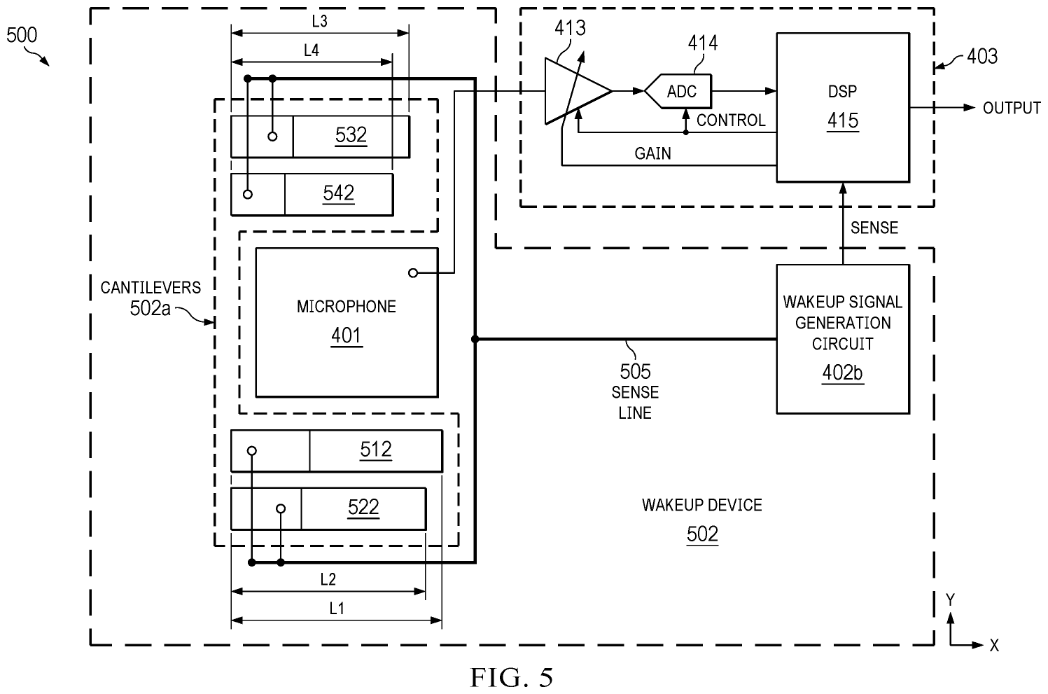

FIG. 5 is a schematic illustrating an audio system 500 with an array of acoustic sensors of the wakeup device coupled to a processing circuitry, according to at least one example. Audio system 500 is like audio system 400 but for arrangement of the array of cantilevers. Array of cantilevers 502a is arranged so that some cantilevers are adjacent to one side of microphone 401 while other cantilevers are adjacent to another side of microphone 401. In at least one example, array of cantilevers 502a of wakeup device 502 (which can be an example of wakeup device 102/202) includes cantilevers 512, 522, 532, and 542.

In at least one example, cantilever 512 has length L1 along an x-direction. In at least one example, cantilever 522 has length L2 along an x-direction, where length L2 is shorter than length L1. In at least one example, cantilever 532 has length L3 along an x-direction, where length L3 is shorter than length L2. Cantilever 542 has length L4 along an x-direction, where length L4 is shorter than length L3. In at least one example, cantilevers 512, 522, 532, and 542 are separated from one another by gap Wgap. In at least one example, each cantilever has a different resonant frequency. In at least one example, the resonant frequency of the cantilevers is different from the resonant frequency of microphone 401. In at least one example, the resonant frequency of the cantilevers is lower than the resonant frequency of microphone 401. In at least one example, each cantilever comprises piezoelectric material. While FIG. 5 illustrates an even number of cantilevers on two opposite sides of microphone 401, array of cantilevers 502a can be arranged in any order relative to sides of microphone 401. For example, cantilever can be on the immediate sides of microphone 401. In at least one example, vibration from cantilevers 512, 522, 532, and 542 is converted as electric signals at electrodes coupled to cantilevers 512, 522, 532, and 542, and these electric signals are transferred to sense line 505.

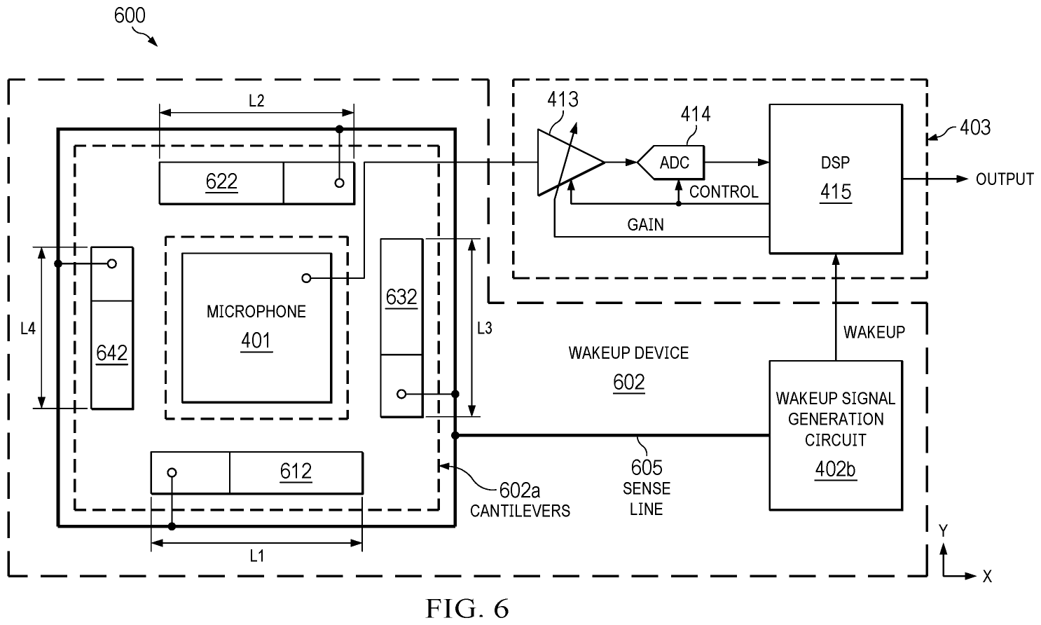

FIG. 6 is a schematic illustrating an audio system 600 with an array of acoustic sensors of the wakeup device coupled to a processing circuitry, according to at least one example. Audio system 600 is like audio system 400 but for arrangement of the array of cantilevers. In at least one example, array of cantilevers 602a of wakeup device 602 (which can be an example of wakeup device 102/202) is arranged so that there is at least one cantilever adjacent to a side of microphone 401. Array of cantilevers 602a includes cantilevers 612, 622, 632, and 642.

In at least one example, cantilever 612 has length L1 along an x-direction. In at least one example, cantilever 622 has length L2 along the x-direction, where length L2 is shorter than length L1. In at least one example, cantilever 632 has length L3 along a y-direction, where length L3 is shorter than length L2. In at least one example, cantilever 642 has length L4 along the y-direction, where length L4 is shorter than length L3. Cantilevers 612, 622, 632, and 642 are separated from one another by gap Wgap. In at least one example, each cantilever has a different resonant frequency. In at least one example, the resonant frequency of the cantilevers is different from the resonant frequency of microphone 401. In at least one example, the resonant frequency of the cantilevers is lower than the resonant frequency of microphone 401. In at least one example, each cantilever comprises piezoelectric material. While FIG. 6 illustrates one cantilever adjacent to a side of microphone 401, array of cantilevers 602a can be arranged in any order relative to sides of microphone 401. In at least one example, multiple cantilevers are adjacent to a side of microphone 401 such that there is at least one cantilever adjacent to each side of microphone 401. In at least one example, vibration from cantilevers 612, 622, 632, and 642 is converted to electric signals at electrodes of cantilevers 612, 622, 632, and 642, and these electric signals are transferred to sense line 605.

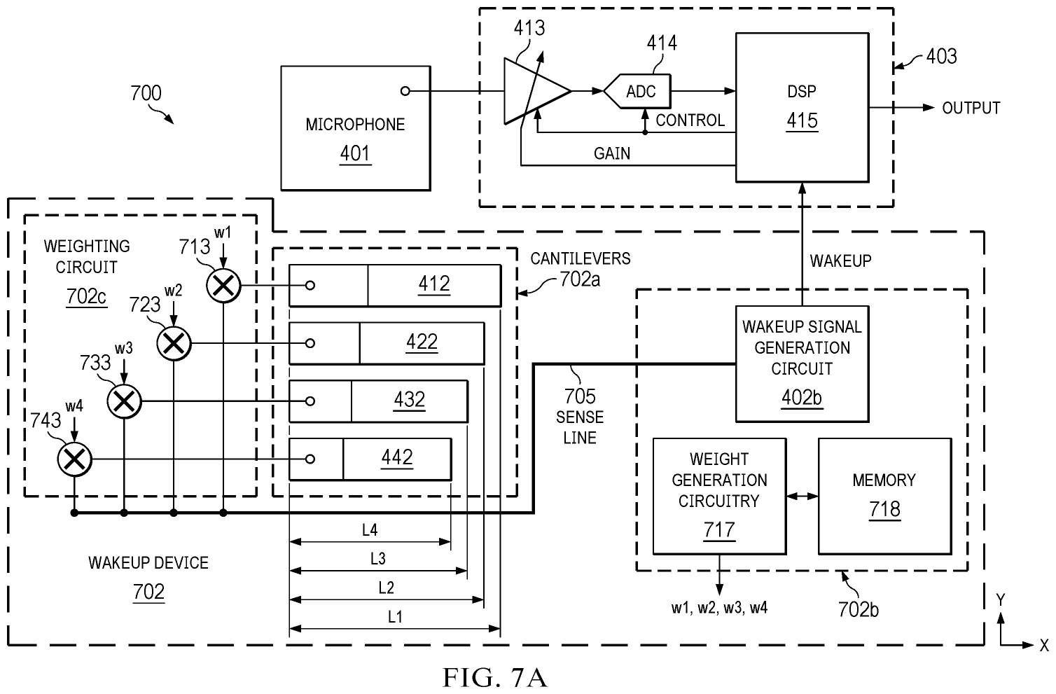

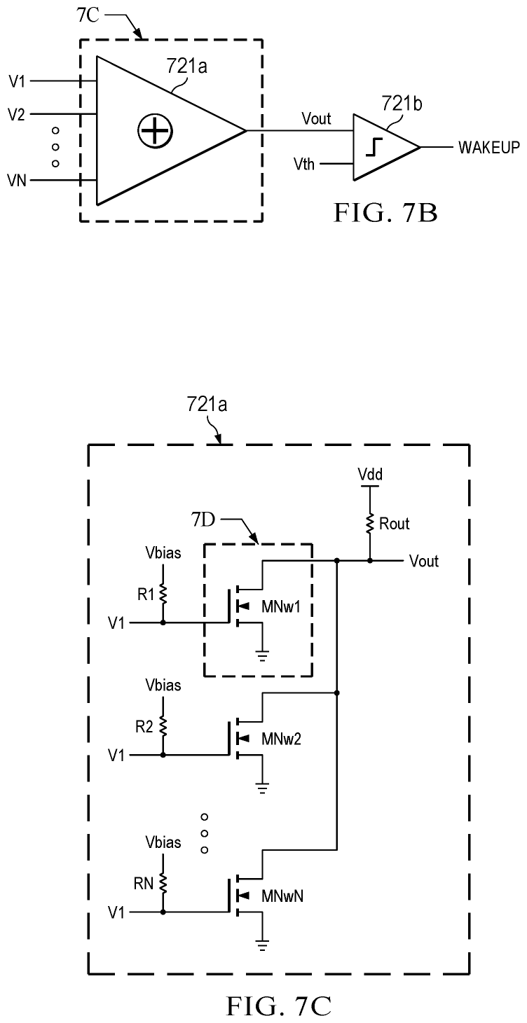

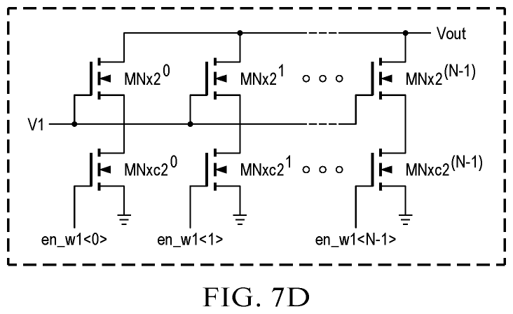

FIG. 7A illustrates an audio system 700, according to at least one example. Audio system 700 can be an example of or can be part of audio system 400 and includes wakeup device 402 of FIG. 4. In FIG. 7A, wakeup device 702 includes weighting circuit 702c and wakeup signal generation circuit 702b, which can be an example of wakeup signal generation circuit 102b of FIG. 1A. In at least one example, weighting circuit 702c comprises a plurality of summation circuitries coupled to cantilever 702a, where an individual summation circuitry is coupled to an electrode of a cantilever and receives an associate weight input. The output of an individual summation circuitry couples to sense line 705. In at least one example, wakeup signal generation circuit 702b includes wakeup processing circuit 402b, weight generation circuitry 717, and memory 718. In at least one example, weights for weighting circuit are stored in memory 718. In at least one example, weights are generated by weight generation circuitry 717 which provides weights to weighting circuit 702c and may also store weights in memory 718. In at least one example, weight generation circuitry 717 includes logic to assign weights according to characteristics of cantilevers (e.g., resonant frequency of cantilever, sensitivity level etc.). In at least one example, weight generation circuitry 717 can dynamically adjust weights to modify effective sensitivity of a cantilever by modifying its output as discussed with reference to FIG. 7B.

In at least one example, weighting circuit 702c comprises summation circuit 713 that receives weight w1 and is coupled to cantilever 412. In at least one example, output of summation circuit 713 couples to sense line 705. In at least one example, weighting circuit 702c comprises summation circuit 723 that receives weight w2 and couples to cantilever 422. In at least one example, output of summation circuit 723 couples to sense line 705. In at least one example, weighting circuit 702c comprises summation circuit 733 that receives weight w3 and couples to cantilever 422. In at least one example, output of summation circuit 733 couples to sense line 705. In at least one example, weighting circuit 702c comprises summation circuit 743 that receives weight w3 and couples to cantilever 422. In at least one example, output of summation circuit 743 couples to sense line 705. In at least one example, one or more cantilevers couple to a summation circuit with associated weight input. In at least one example, not all cantilevers are coupled to a summation circuit with associated weight input. In at least one example, the weights w1, w2, w3, and w4 are digital signals or bits that turn on/off transistors (e.g., field effect transistors (FETs)) of respective summation circuits 713, 723, 733, and 743 to modify output on sense line 705. In at least one example, weights w1 through w4 associated with the individual cantilever can be adjusted based on the frequency content of a vocal audio. In at least one example, de-sensitization of the non-essential audio is enabled through the configurable weights w1 through w4.

FIG. 7B is a schematic illustrating an apparatus 720 with a weighting circuitry, according to at least one example. Apparatus 720 can be part of weighing circuit 702c and/or part of wakeup processing circuit 402b. In at least one example, apparatus 720 includes weighting circuitry 721a (e.g., weighting circuit 702c) and comparator 721b (e.g., wakeup signal generation circuit 402b). Comparator 721b is any suitable comparator that compares Vout with a programmable or predetermined threshold or reference Vth. In at least one example, the output of comparator 721b provides a wakeup signal, which is then used to wake up part of the audio system that is in a low power (or sleep) mode (e.g., processing circuitry 103/403 and/or control and processing circuit 352).

FIG. 7C is a schematic illustrating weighting circuitry 721a, according to at least one example. In at least one example, weighting circuitry 721a comprises n-type transistors MNw1, MNw2, through MNwN, resistors R1, R2, through RN coupled to Vbias, and output node Vout (e.g., sense line 705). In at least one example, the gate terminal of transistor or nFET MNw1 couples to node v1, which connects to the first cantilever. In at least one example, node v1 couples to Vbias via resistor R1. Any suitable circuit generates Vbias such as bandgap circuit, resistor divider, and voltage divider. In at least one example, the voltage level of Vbias is between 0V and supply voltage (Vdd). In at least one example, any suitable circuit generates voltage level of Vbias to be equal to a threshold voltage of an n-type transistor (e.g., n-type transistor MNw1).

In at least one example, the gate terminal of transistor MNw2 couples to node v2, which connects to the second cantilever. In at least one example, node v2 couples to Vbias via resistor R2. In at least one example, the gate terminal of transistor MNwN couples to node vN, which connects to the Nth cantilever. In at least one example, node vN couples to Vbias via resistor RN. In at least one example, source terminals of transistors MNw1, MNw2, and MNwN couple to ground. In at least one example, drain terminals of transistors MNw1, MNw2, and MNwN coupled to Vout. Here, Rout represents the output impedance from node Vout looking into drain terminals of transistors MNw1, MNw2, and MNwN. In at least one example, each transistor MNw1, MNw2, and MNwN comprises a programmable transistor whose total width (and thus driving strength or resistance) is programmable by weight enable bits.

FIG. 7D is a schematic illustrating a set of binary weighted transistors representing transistor MNw1 of weighting circuitry 721a, according to at least one example. In at least one example, transistor MNw1 of weighting circuitry 721a represents binary weighted n-type transistors MNx2⁰, and MNx2¹ through MNx2^{(N-1)} having gate terminals coupled to node v1, drain terminals coupled to Vout, and source terminals coupled to digitally controlled binary weighted transistors MNxc2⁰, and MNxc2¹ through MNxc2^{(N-1)}. In at least one example, en_w1<0> bit (e.g., one of bits w1 in FIG. 7B) controls n-type transistor MNxc2⁰. In at least one example, en_w1<1> bit (e.g., one of bits w1 in FIG. 7B) controls n-type transistor MNxc2¹. In at least one example, en_w1<N−1> bit (e.g., one of bits w1 in FIG. 7B) controls n-type transistor MNxc2^{(N-1)}. In at least one example, bit values for en_w1<0>, en_w1<1>, . . . en_w1<N−1> change the total effective width of transistor MNw1. In at least one example, software, hardware (e.g., weight generation circuitry 717), or a combination of them programs logic value of each bit en_w1<0>, en_w1<1>, . . . en_w1<N−1>.

In at least one example, voltage on node Vout can be expressed as:

$$Vout = Rout {\sum }_{i} {gm}_{i} \cdot {v}_{i}$$

where gm is the transconductance of transistor MNwi, where ‘i’ is a number, and vᵢ is the ith node connected to the ith cantilever. In at least one example, thermometer weighted transistors may replace binary weighted MNx2⁰, MNx2¹ through MNx2^{(N-1)}. In at least one example, weights or enable signals representing binary weights (e.g., bit values for en_w1<0>, en_w1<1>, en_w1<N−1>) can be encoded as thermometer weights.

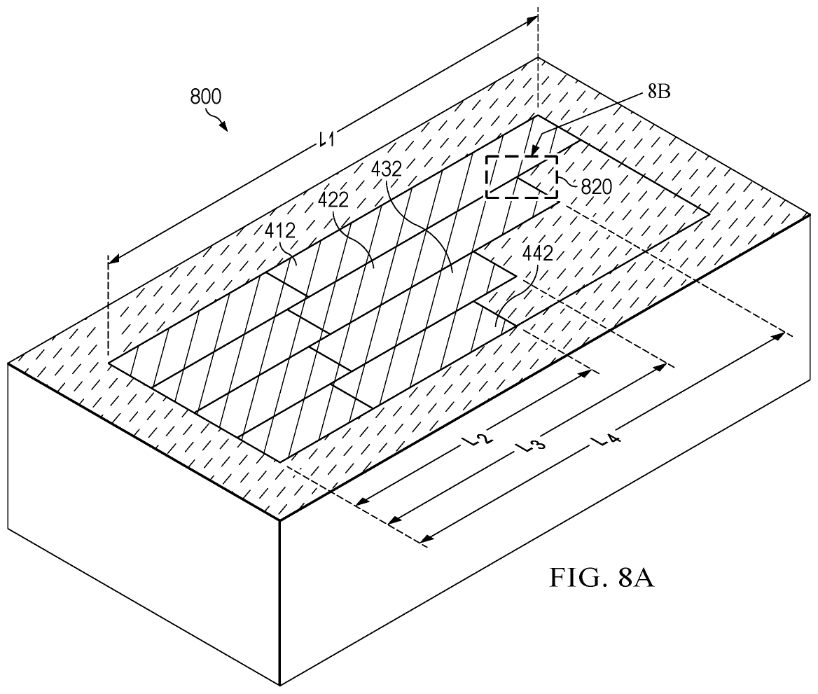

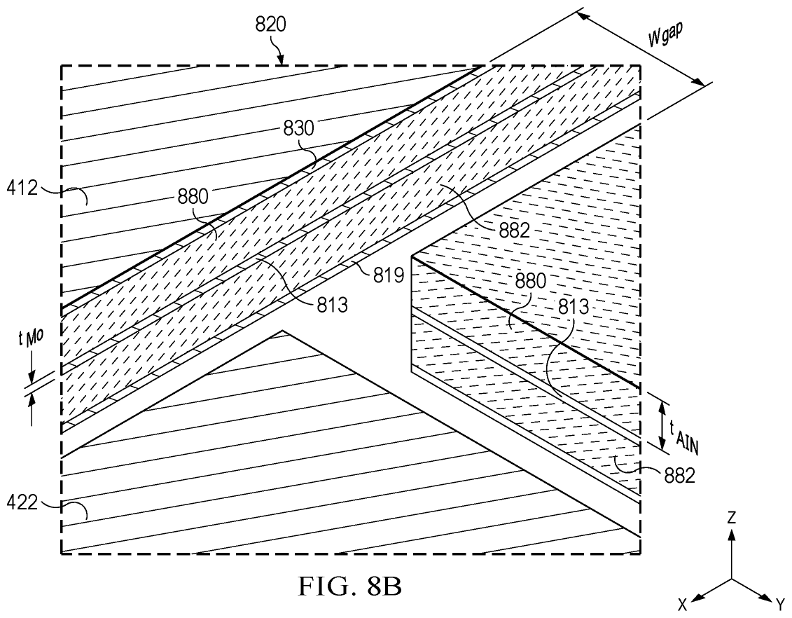

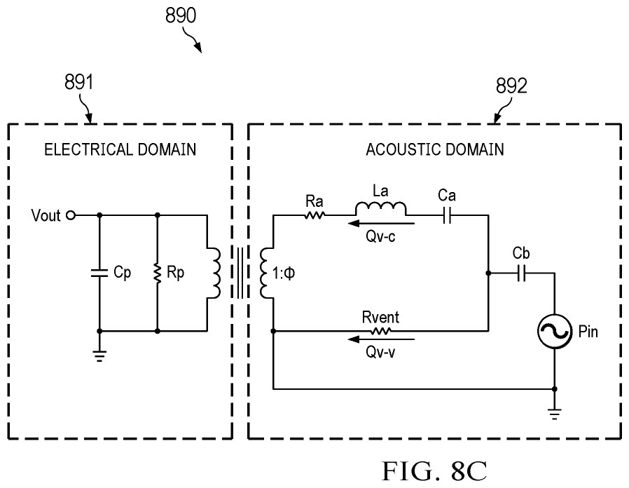

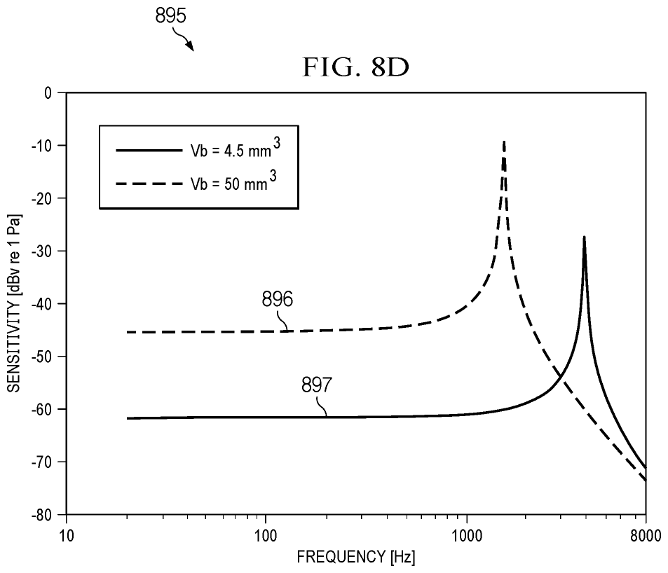

FIG. 8A is a schematic illustrating an array of acoustic sensors 800 based on cantilevers, according to at least one example. Acoustic sensors 800 can be part of any of the wakeup devices described herein. In at least one example, array of acoustic sensors 800 are fabricated over substrate 290. In at least one example, there is a minimum gap Wgap between adjacent cantilevers.

FIG. 8B is a schematic illustrating a zoomed section 820 of cantilevers of array of acoustic sensors 800, according to at least one example. Zoomed section 820 covering portions of cantilevers 412 and 422 illustrates bimorph structure of the cantilevers. In at least one example, cantilever 412 includes top electrode 830, middle electrode 813 and bottom electrode 819. In at least one example, cantilever 412 has similar structure or configuration as piezoelectric bimorph flaps 322A and 322B of microphone 301. In at least one example, cantilever 412 comprises first piezoelectric layer 880 between top electrode 830 and middle electrode 813. In at least one example cantilever 412 comprises second piezoelectric layer 882 between middle electrode 813 and bottom electrode 819. In at least one example, top electrode 830, middle electrode 813, and bottom electrode 819 comprise molybdenum.

In at least one example, first piezoelectric layer 880 and second piezoelectric layer 882 comprise aluminum nitride (AlN). In at least one example, first piezoelectric layer 880 has a thickness tAlN which is same as thickness along z-direction for second piezoelectric layer 882. In at least one example, first piezoelectric layer 880 has thickness tAlN which is different than thickness along z-direction for second piezoelectric layer 882. Vibrations from bending of first piezoelectric layer 880 and second piezoelectric layer 882 are converted into electrical signal on the electrodes of the cantilever. In at least one example, electric terminals are coupled to electrodes of cantilever and connected to a sense line which in turn is received by a wakeup signal generation circuit.

FIG. 8C is a schematic illustrating a circuit model 890 of array of acoustic sensors 800, according to at least one example. In at least one example, equivalent circuit model 890 comprises an electrical domain 891 and acoustic domain 892. Resistor Rp, capacitor Cp, and a transformer models electrical domain 891, where resistor Rp is the equivalent resistance of piezoelectric layer and capacitor Cp is equivalent capacitance from the piezoelectric layer. The voltage sensed from electrical domain 891 is Vout. In at least one example, the transformer with winding ratio of 1:Φ indicates the transduction of vibration from acoustic domain 892 to electrical domain 891, where Φ is electromechanically transduction coefficient.

In at least one example, series coupled resistor Ra, inductor La, and capacitor Ca, which together are parallel to vent resistor Rvent, model acoustic domain 892. Here, Ra is the cantilever acoustic resistance, La is the cantilever acoustic inertance, Ca is the cantilever acoustic compliance, Rvent is the vent resistance, and Cb is the back volume compliance, Qv-v is the vent volume velocity, and Qv-c is the cantilever volume velocity. In at least one example, alternating current or pressure source Pin which is coupled to capacitor Ca and vent resistor Rvent via capacitor Cb models acoustic input or audio received by the cantilever. In at least one example, the resonant frequency of the cantilever is expressed as:

$${f}_{0} = \frac{1}{2 π} \sqrt{\frac{1}{{L}_{a} ( \frac{{C}_{a} {C}_{b}}{{C}_{a} + {C}_{b}}}}$$

FIG. 8D includes a plot 895 with graphs showing sensitivity of two acoustic sensors (e.g., two piezoelectric cantilevers) with respect to frequency, according to at least one example. Plot 895 shows resonant frequencies for two different acoustic sensors as indicated by graphs 896 and 897.

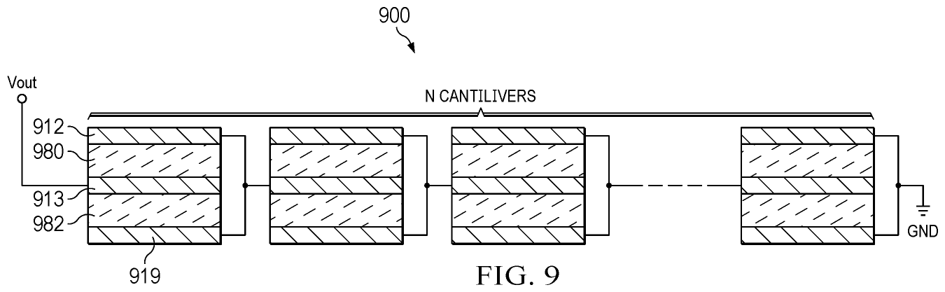

FIG. 9 is a schematic illustrating electrical coupling of individual acoustic sensors of an array of acoustic sensors 900, according to at least one example. In FIG. 9, array of N acoustic sensors 900 are electrically coupled in series to, for example, set the overall frequency response and/or amplify the output voltage. In at least one example, an acoustic sensor includes a bimorph cantilever (e.g., cantilever 412/512/612, 422/522/622, 432/532/632, or 442/542/642) with top electrode 912, middle electrode 913, and bottom electrode 919. In at least one example, array of N acoustic sensors 900 may be part of any of the wakeup device described herein. First piezoelectric layer 980 is between top electrode 912 and middle electrode 913. Second piezoelectric layer 982 is between middle electrode 913 and bottom electrode 919. In at least one example, a top electrode and a bottom electrode of a cantilever is connected to a middle electrode of a subsequent or adjacent cantilever. In at least one example, middle electrode 913 of the first cantilever provides the output voltage Vout. In at least one example, the top and bottom electrodes of the last cantilever are connected to ground. In some examples, a wakeup device can include multiple arrays of acoustic sensors, and a weighting circuit (e.g., weighing circuit 702c) to scale the Vout of each array.

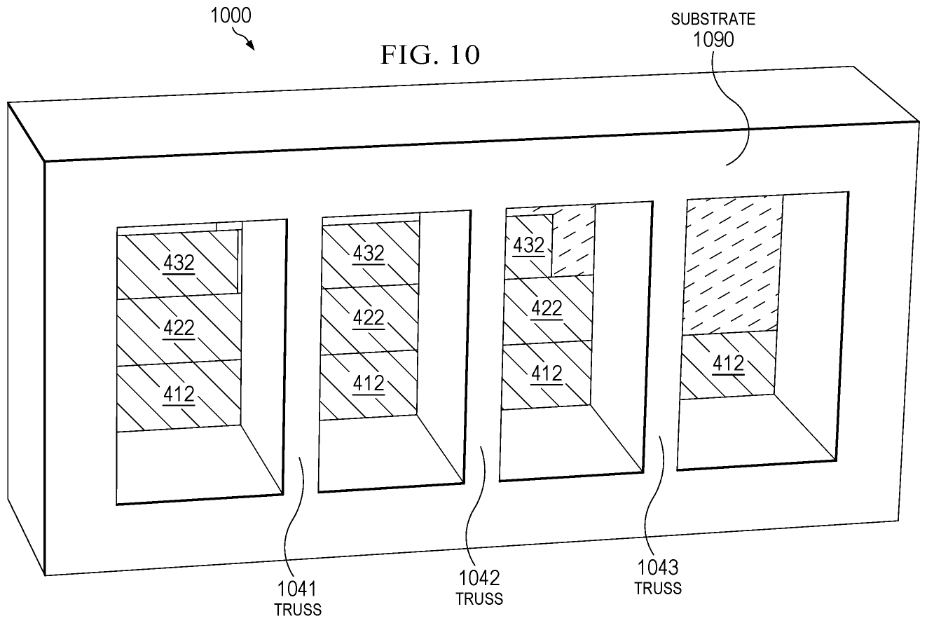

FIG. 10 is a schematic illustrating a backside view 1000 of an array of acoustic sensors (e.g., piezoelectric cantilevers) over trusses of a substrate, according to at least one example. In at least one example, the array of acoustic sensors (e.g., cantilevers 412, 422, 432, and 442) are under substrate 1090 with trusses 1041, 1042, and 1043. In at least one example, trusses 1041, 1042, and 1043 are silicon trusses or ridges that partition front volume and improve operational reliability from a burst pressure perspective. In at least one example, cantilevers 412, 422, 432, and 442 have different lengths. The cantilevers can be electrically coupled (e.g., as shown in FIG. 9) or mechanically coupled together to obtain a desired frequency response. In at least one example, any number of trusses can be formed under the array of acoustic sensors. The size of holes between the trusses is selected to allow maximum audio interaction with the acoustic sensors. In at least one example, the trusses are used to provide support for cantilevers 412, 422, 432, and 442 when they are in parked state. In at least one example, cantilevers 412, 422, 432, and 442 are parked or clamped on one of the trusses to mitigate interference with the microphone (e.g., microphones 101, 201, 301, 401, etc.) that shares the back volume space with the cantilevers of the wakeup device.

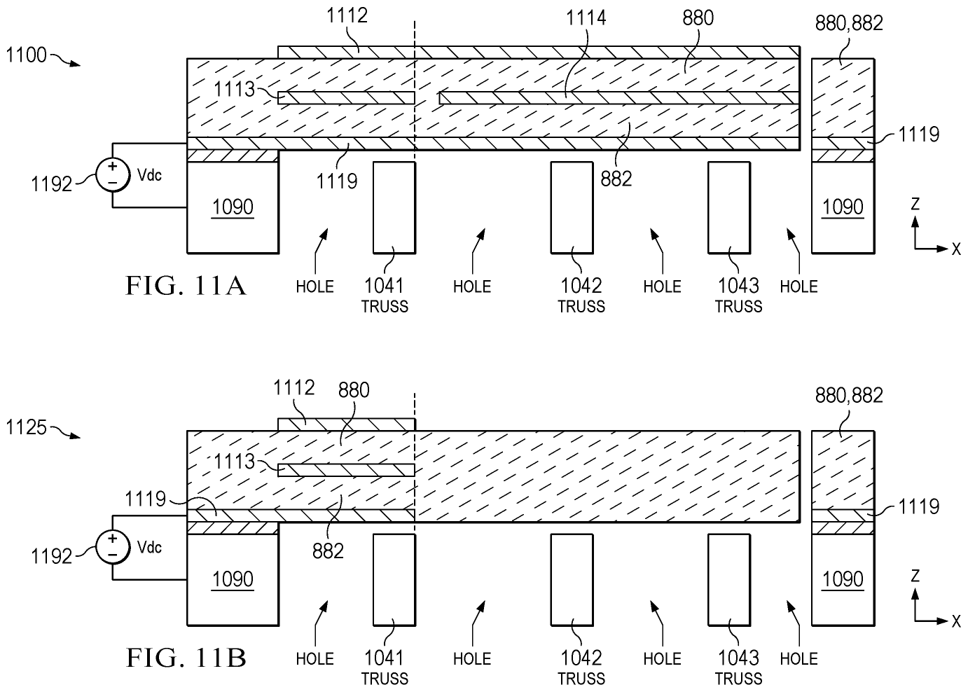

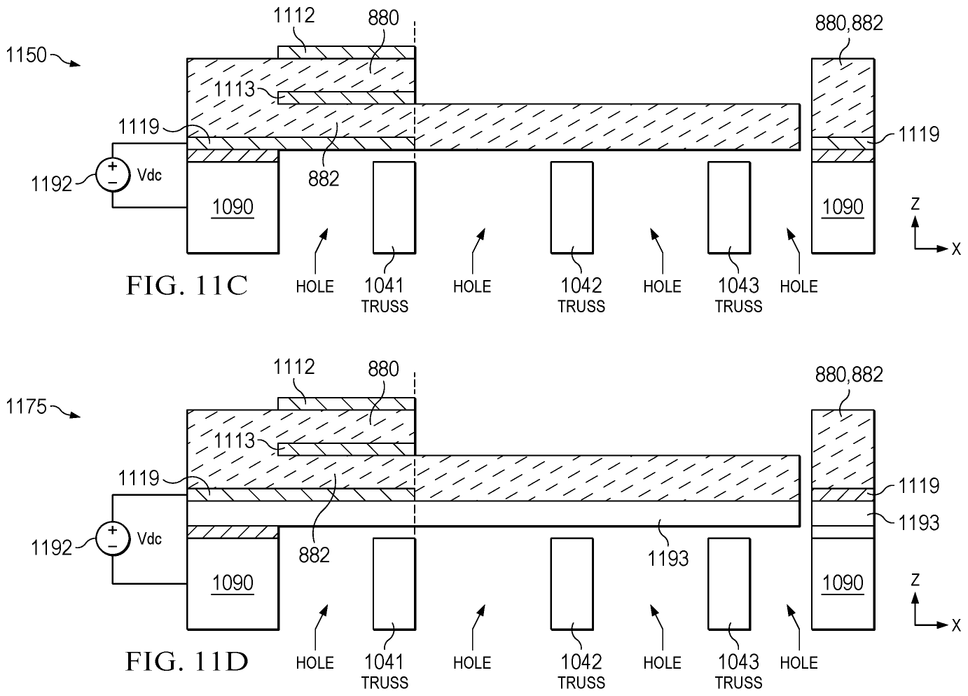

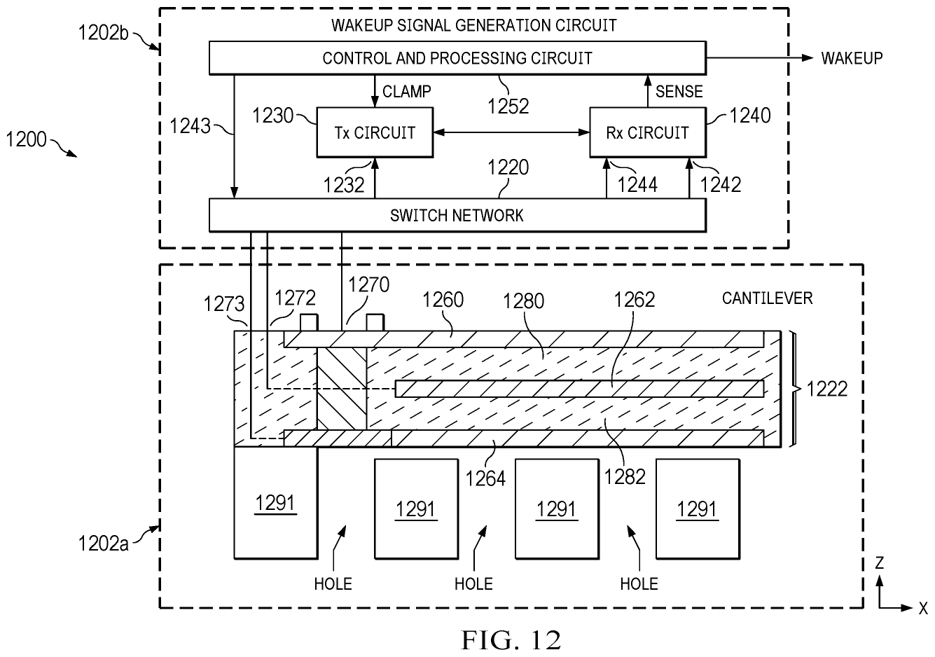

FIGS. 11A, 11B, 11C, and 11D are schematics illustrating cross-sections of piezoelectric bimorph cantilevers 1100, 1125, 1150, and 1175 of a wakeup device, according to some examples. Piezoelectric bimorph cantilevers 1100, 1125, 1150, and 1175 can be part of any wakeup device described herein. In at least one example, piezoelectric bimorph cantilever 1100 comprises top electrode 1112, middle electrodes 1113 and 1114, and bottom electrode 1119. In at least one example, middle electrodes 1113 and 1114 are on the same layer. In at least one example, piezoelectric bimorph cantilever 1100 comprises first piezoelectric layer 880 between first electrode 1113 and middle electrodes 1113 and 1114. In at least one example, piezoelectric bimorph cantilever 1100 comprises second piezoelectric layer 882 between bottom electrode 1119 and middle electrodes 1113 and 1114.

In at least one example, material for first piezoelectric layer 880 is same as material for second piezoelectric layer 882. In at least one example, material for first piezoelectric layer 880 different from the material for second piezoelectric layer 882. In at least one example, thickness (in the z-direction) for first piezoelectric layer 880 is same as thickness (in the z-direction) for second piezoelectric layer 882. In at least one example, the thickness (in the z-direction) of first piezoelectric layer 880 is different from the thickness (in the z-direction) of second piezoelectric layer 882. By changing thickness and/or material composition of first piezoelectric layer 880 relative to second piezoelectric layer 882, sensitivity and/or resonant frequency of piezoelectric bimorph cantilever 1100 can be modified.

In at least one example, trusses 1041, 1042, and 1043 formed in substrate 1090 result in holes in substrate 1090 through which audio exerts pressure onto piezoelectric bimorph cantilever 1100 and causes it to vibrate, and the resulting stress creates electrical signals at the electrodes 1112, 1114, and 1119. In at least one example, voltage source 1192 applies voltage between the substrate and bottom electrode 1119, which can create an electrostatic force to clamp/park cantilever 1100/112/1150/1175 on trusses 1041, 1042, and 1043, to stop piezoelectric bimorph cantilever 1100 from causing interference with microphone 101 where microphone 101 and piezoelectric bimorph cantilever 1100 share the same back volume. Voltage source 1192 can also apply voltages between middle electrode 1113 and top electrode 1112 and bottom electrode 1119 to create an actuation force in piezoelectric bimorph cantilever 1100 to clamp/park the cantilever on the trusses.

In at least one example, piezoelectric bimorph cantilever 1125 is similar to piezoelectric bimorph cantilever 1100 but without metal layers in the moveable portion of piezoelectric bimorph cantilever 1125. In at least one example, functionally, piezoelectric bimorph cantilever 1125 performs like piezoelectric bimorph cantilever 1100 but may have different sensitivity to received audio.

In at least one example, piezoelectric bimorph cantilever 1150 is similar to piezoelectric bimorph cantilever 1125 but without first piezoelectric layer 880 in the moveable portion of piezoelectric bimorph cantilever 1150. Functionally, piezoelectric bimorph cantilever 1150 performs like piezoelectric bimorph cantilever 1125 but may have different sensitivity to received audio.

In at least one example, piezoelectric bimorph cantilever 1175 is similar to piezoelectric bimorph cantilever 1150, but with an additional layer of substrate 1193 between bottom electrode 1119 and substrate 1090 (which may be part of a truss or ridge). In at least one example, functionally, piezoelectric bimorph cantilever 1175 performs like piezoelectric bimorph cantilever 1150 but may have different sensitivity to received audio.

In at least one example, DC actuation voltage from voltage source 1192 can be applied to clamp piezoelectric bimorph cantilevers down to the trusses (e.g., trusses 1041 through 1043) when wakeup mode is disabled. In at least one example, clamping the piezoelectric bimorph cantilevers prevents interference to the operation of microphone 101 through back volume acoustic coupling. Different cantilever material stack configurations can be used for tailoring stiffness and hence sensitivity of the cantilever.

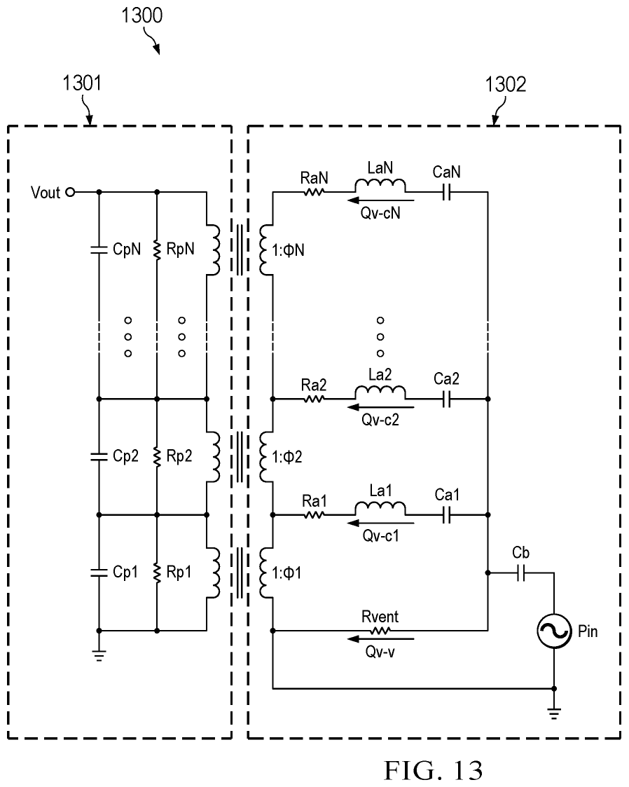

FIG. 12 is a schematic illustrating a wakeup device 1200 coupled to a processing circuitry, according to at least one example. In at least one example, wakeup device 1200 comprises cantilever 1202a and wakeup signal generation circuit 1202b. Wakeup device 1200 can be an example of any of the wakeup devices described herein. In at least one example, cantilever 1202a comprises piezoelectric bimorph cantilever 1222, terminals 1270, 1272, and 1273, substrate 1291 with trusses 1041, 1042, and 1043 that provide holes or openings to piezoelectric bimorph cantilever 1222. In at least one example, wakeup signal generation circuit 1202b includes switch network 1220, transmit circuit 1230 (herein, Tx circuit), receive circuit 1240 (herein Rx circuit), and control and processing circuit 1252. In at least one example, wakeup signal generation circuit 1202b includes apparatus of FIG. 7B.

In at least one example, piezoelectric bimorph cantilever 1222 has a multi-layer structure. In at least one example, piezoelectric bimorph cantilever 1222 has top electrode 1260, middle electrode 1262, bottom electrode 1264, first piezoelectric layer 1280 between top electrode 1260 and middle electrode 1262. In at least one example, second piezoelectric layer 1282 is between middle electrode 1262 and bottom electrode 1264. Although the illustrated portion of cantilever 1202a shows one piezoelectric bimorph cantilever 1222, cantilever 1202a may include any suitable number of piezoelectric bimorph cantilever as discussed herein.

In at least one example, piezoelectric layer 1280 has at least a portion between top electrode 1260 and middle electrode 1262. In at least one example, second piezoelectric layer 1282 has at least a portion between middle electrode 1262 and bottom electrode 1264. Top electrode 1260 and bottom electrode 1264 couple to terminal 1270. In at least one example, middle electrode 1262 couples to terminal 1272. In at least one example, terminal 1270, terminal 1272, and terminal 1273 couple to switch network 1220 of wakeup signal generation circuit 1202b.

In at least one example, electrodes 1260, 1262, and 1264 may each be formed from one or more layers of any suitable conductive material(s). In at least one example, piezoelectric layers 1280 and 1282 may each be formed of any suitable piezoelectric material(s). In at least one example, electrodes 1260, 1262, and 1264 and piezoelectric layers 1280 and 1282 are formed using material(s) compatible with certain CMOS processing. In at least one example, electrodes 1260, 1262, and 1264 comprise molybdenum (Mo or “moly”). In at least one example, piezoelectric layers 1280 and 1282 comprise aluminum nitride (“AlN”). In at least one example, electrodes 1260, 1262, and 1264 and piezoelectric layers 1280 and 1282 may be formed with any suitable bimorph material(s).

In at least one example, terminals 1270, 1272, and 1273 can include any suitable electrical connector configured to transfer electrical current. In at least one example, terminals 1270 and 1272 electrically couple piezoelectric bimorph cantilever 1222 to Rx circuit 1240 via switch network 1220. Terminal 1273 electrically couples substrate 1291 and bottom electrode 1264/top electrode 1260 to Tx circuit 1230 via switch network 1220.

In at least one example, switch network 1220 can include any suitable electrical component(s) to disconnect or connect conductive paths interconnecting control and processing circuit 1252 to piezoelectric bimorph cantilever 1222. In at least one example, switch network 1220 disconnects or connects respective conductive paths to terminals 1270, 1272, and/or 1273. In at least one example, switch network 1220 has input terminals coupled to driver output 1232 of Tx circuit 1230 and may further have output terminals coupled to receiver inputs 1242 and 1244 of Rx circuit 1240. In at least one example, control and processing circuit 1252 sets mode of operation of switch network 1220 via control 1243 to multiplex signals coming from or going to terminals 1270, 1273, and 1272 to appropriate Tx circuit 1230 or Rx circuit 1240.

In at least one example, Tx circuit 1230 includes circuitry that receives a clamp signal (or a disable signal) from control and processing circuit 1252. Responsive to the clamp signal, Tx circuit 1230 can transmit a DC voltage via switch network 1220 to terminals 1270 and 1272. In at least one example, control and processing circuit 1252 generates the clamp signal after piezoelectric bimorph cantilever 1222 senses an audio that results in generation of the wakeup output that wakes one or more circuits of processing circuitry 103. In at least one example, Tx circuit 1230 can apply the DC voltage across substrate 1291 and bottom electrode 1264 to clamp cantilever 1222 onto trusses 1041, 1042, and 1043. Control and processing circuit 1252 can generate the clamp signal after generating the wakeup signal to mitigate any interference with operation of microphone 101 by wakeup device 102.

In at least one example, Rx circuit 1240 includes circuitry that receives electrical signals at receiver inputs 1242 and 1244 from switch network 1220, which represent an electric field between electrodes 1260, 1262, and 1264 that reflect a stress in piezoelectric bimorph cantilever 1222 due to the sound waves. Rx circuit 1240 provides corresponding electrical signals to control and processing circuit 1252. In at least one example, piezoelectric bimorph cantilever 1222 vibrates responsive to soundwaves, resulting in stress that is converted into an electrical signal that is provided to Rx circuit 1240 via inputs 1242 and 1244. In at least one example, Rx circuit 1240 performs a conversion operation on received electrical signals. In at least one example, Rx circuit 1240 performs an analog-to-digital conversion that involves receiving analog electrical signals at receiver inputs 1242 and 1244 and converting the received analog electrical signals to digital electrical signals. In at least one example, control and processing circuit 1252 receives the converted digital electrical signals. Rx circuit 1240 provides analog signals to control and processing circuit 1252. In at least one example, an internal analog-to-digital converter of Rx circuit 1240 converts the analog signals to digital signals. In at least one example, control and processing circuit 1252 provides wakeup output to processing circuitry 103.

In at least one example, control and processing circuit 1252 includes circuitry capable of providing control signal to piezoelectric bimorph cantilever 1222, receiving electrical signals from piezoelectric bimorph cantilever 1222 representing detection of sound waves, and providing processing functions concerning the provided electrical driving signals or received response signals. In at least one example, control and processing circuit 1252 can be part of an application specific integrated circuit (ASIC). Control and processing circuit 1252 may include one or more physical processor devices executing instructions stored in non-transitory memory to perform the processing and control functions.

In at least one example, piezoelectric bimorph cantilever 1222 includes multiple layers forming a stack. In at least one example, piezoelectric bimorph cantilever 1222 includes substrate 1291 (e.g., a silicon substrate). Substrate 1291 includes trusses 1041, 1042, and 1043 with holes which permits sound waves to be transmitted to piezoelectric bimorph cantilever 1222.

FIG. 13 is a schematic illustrating a circuit model 1300 of an array of cantilever sensors, according to at least one example. In at least one example, equivalent circuit model 1300 comprises an electrical domain 1301 and an acoustic domain 1302 which models the array of cantilevers. In at least one example, equivalent circuit model 1300 is based on equivalent circuit model 890 and captures multiple cantilevers coupled in series as shown in FIG. 9.

In at least one example, multiple instances of a resistor Rp, a capacitor Cp, and a transformer coupled with one another, where resistor Rp is the resistance of piezoelectric layer and capacitor Cp is capacitance from the piezoelectric layer, model electrical domain 1301. In this example, ‘N’ such instances are coupled together, where ‘N’ is a positive number. In at least one example, capacitor Cp1, resistor Rp1, and a first transformer coil represent a first bimorph cantilever. In at least one example, capacitor Cp2, resistor Rp2, and a second transformer coil represent a second bimorph cantilever adjacent to the first bimorph cantilever. In at least one example, capacitor CpN, resistor RpN, and a Nth transformer coil represent a Nth bimorph cantilever adjacent to the N−1th bimorph cantilever. In at least one example, capacitor Cp1 couples in series with capacitor Cp2, and so on to capacitor CpN. In at least one example, resistor Rp1 couples in series with resistor Rp2, and so on to resistor RpN. In at least one example, the first transformer coil couples in series with the second transformer coil, and so on to Nth transformer coil.

The voltage sensed from electrical domain 1301 is Vout. In at least one example, acoustic domain 1302 with a plurality of transformers with winding ratio of 1:Φ indicates the transduction of vibration from acoustic domain 1302 to electrical domain 1301. In at least one example, a series coupled resistor Ra, inductor La, and capacitor Ca, which together are parallel to resistor Rvent, models acoustic domain 1302. In at least one example, an alternating current or pressure source Pin which couples to capacitor Ca and resistor Rvent via capacitor Cb models the acoustic input or audio received by the array of cantilevers.

In at least one example, acoustic domain 1302 models the first bimorph cantilever by series coupled resistor Ra1, inductor La1, and capacitor Ca1, which together are parallel to resistor Rvent, where resistor Ra1 is coupled to the first transformer with winding ratio 1:Φ1. In at least one example, acoustic domain 1302 models the second bimorph cantilever by series coupled resistor Ra2, inductor La2, and capacitor Ca2, where resistor Ra2 is coupled to the second transformer with winding ratio 1:Φ2. In at least one example, acoustic domain 1302 models the Nth bimorph cantilever by series coupled resistor RaN, inductor LaN, and capacitor CaN, where resistor RaN is coupled to the Nth transformer with winding ratio 1:ΦN. In at least one example, an alternating current or pressure source Pin models acoustic input or audio received by the array of cantilevers.

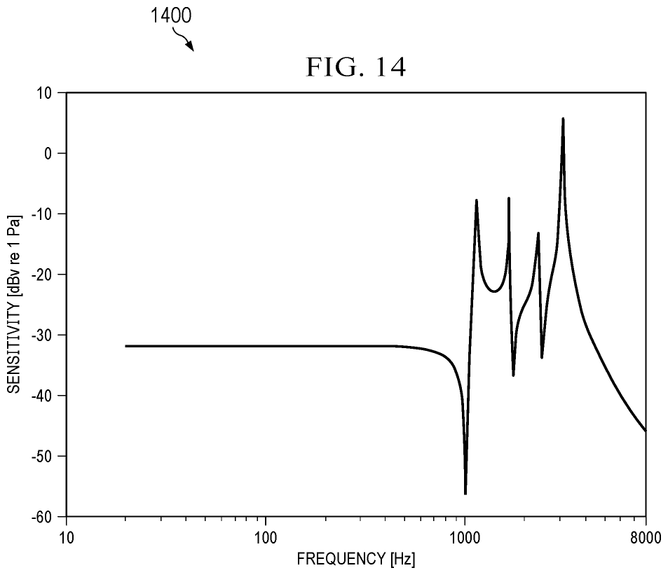

FIG. 14 includes a plot 1400 with a graph showing sensitivity of a cantilever sensor with respect to frequency, according to at least one example. Plot 1400 illustrates high passband sensitivity. In this example, the acoustic sensor of the wakeup device has a relatively high sensitivity to vibration within the 1.1 kHz to 3 kHz band, and a relatively low sensitivity to vibration outside the 1.1-3 kHz band. This passband can be in a lower frequency band than a microphone, where overall frequency response of an audio system (e.g., audio system 105) has an overall flat passband from a lower corner frequency (e.g., defined by the gap/slit width) up to a maximum audible frequency (e.g., 20 kHz). The passband of the wakeup device, in contrast, may be relatively narrow and associated with certain speech signals from a user (e.g., a wakeup voice command). Accordingly, the frequency response of the wakeup device can be different from that of an audio system including a microphone and can be optimized to detect certain wakeup voice commands. Also, because the audio system and the wakeup device have separate acoustic sensors, the frequency responses of the acoustic sensors can be separately optimized/configured (e.g., based on setting the physical dimensions, mass loading, etc.), while the acoustic sensor of an audio system is configured to provide a flat passband across the audible frequency range, while the acoustic sensor of the wakeup device is configured to have a passband associated with specific speech signals, while being insensitive (or having a lower sensitivity) to other signals, such as background noise.

FIG. 15 illustrates a wakeup device including a capacitive sensor 1500, according to at least one example. In at least one example, capacitive sensor 1500 comprises cantilever 1501 (e.g., dual capacitive cantilever) of length L with one end connected to fixed end 1502 and the other end being a free end. In at least one example, capacitive sensor 1500 comprises top electrode 1503, middle electrode 1504, and bottom electrode 1505. In at least one example, top electrode 1503 is separated from middle electrode 1504 by distance d1. In at least one example, bottom electrode 1505 is separated from middle electrode 1504 by distance d2. In at least one example, cantilever 1501 comprises metal that forms middle electrode 1504. In at least one example, capacitive sensor 1500 comprises two parallel-plate capacitors with reference to two electrodes placed on top electrode 1503 and bottom electrode 1505.

In at least one example, the capacitance of each capacitor is given by:

$$C = \frac{ϵ A}{d}$$

where ∈ is the permittivity of air, A is the area of the plates, and d is the distance between the electrode (e.g., d1 and d2). In at least one example, when cantilever 1501 is deflected, as shown by dotted cantilever 1501a, the value of capacitor C1 decreases due to increased distance d1 between top electrode 1503 and middle electrode 1504, and capacitor C2 increases in capacitance. In at least one example, cantilever 1501 is at the resting point, (e.g., no bending) the capacitors have the same capacitance C1=C2. In at least one example, when displaced, the capacitances C2 and C1 change linearly to from a first capacitance (e.g., 100 nF) to a second capacitance (e.g., 50 nF), respectively. In at least one example, capacitive sensor 1500 can replace piezoelectric bimorph cantilevers discussed herein. In at least one example, a combination of piezoelectric bimorph cantilever and capacitive sensor 1500 can be used in an audio device, including examples of the wakeup device described herein.

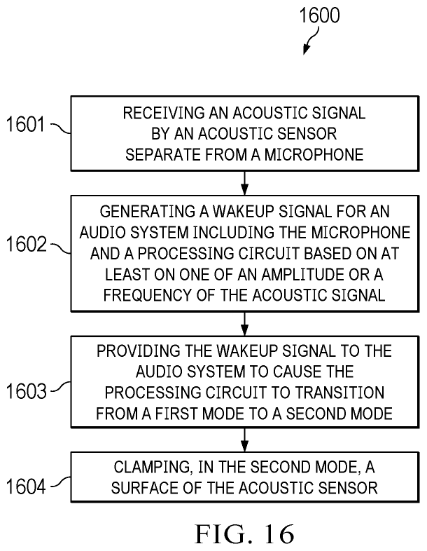

FIG. 16 illustrates a method 1600 of waking a microphone by an acoustic sensor, according to at least one example. In at least one example, one or more blocks of method 1600 can be performed by hardware, software, or a combination of them. In at least one example, at block 1601, one or more acoustic sensors receive an acoustic signal (e.g., a first audio of a first frequency). In at least one example, at block 1602, wakeup signal generation circuit 102b generates a wakeup signal (e.g., wakeup) for an audio system including microphone 101 and processing circuit 103 based at least on one of an amplitude or a frequency of the acoustic signal. In at least one example, at block 1603, wakeup signal generation circuit 102b provides the wakeup signal to the audio system to cause the processing circuit to transition from a first mode (e.g., a low power mode or an off/sleep state) to a second mode (e.g., an active or normal state). In at least one example, at block 1604, wakeup signal generation circuit 102b clamps or parks the acoustic sensor to mitigate interference in the back volume space shared with the microphone. In at least one example, microphone receives a second audio having a second frequency after microphone 101 is in active mode or waken up. In at least one example, the first frequency is different than the second frequency.

Following are additional examples provided in view of the above-described implementations. Here, one or more features of example, in isolation or in combination, can be combined with one or more features of one or more other examples to form further examples also falling within the scope of the disclosure. As such, one implementation can be combined with one or more other implementation without changing the scope of disclosure.

Example 1 is an acoustic device comprising: an audio system including: a microphone having a microphone output, and a processing circuit having a wakeup input, an audio input, and an audio output, the audio input coupled to the microphone output; an acoustic sensor separate from the microphone, the acoustic sensor having a sensor output; and a wakeup signal generation circuit having a sensor input and a wakeup output, the sensor input coupled to the sensor output, wherein the wakeup output is coupled to the wakeup input.

Example 2 is an acoustic device of any example herein, particularly example 1, wherein the processing circuit is configured to enter a first mode responsive to the wakeup input in a first state, and to enter a second mode responsive to the wakeup input in a second state.

Example 3 is an acoustic device of any example herein, particularly example 1, wherein the processing circuit is disabled in the first mode.

Example 4 is an acoustic device of any example herein, particularly example 2, wherein the processing circuit is configured to: in the first mode, sample an audio signal at the audio input at a first rate; and in the second mode, sample the audio signal at the audio input at a second rate, in which the first rate is lower than the second rate.

Example 5 is an acoustic device of any example herein, particularly example 1, wherein the wakeup signal generation circuit includes a comparator having a first comparator input, a reference input, and a comparator output, the first comparator input coupled to the sensor input, and the comparator output coupled to the wakeup output.

Example 6 is an acoustic device of any example herein, particularly example 1, wherein the processing circuit includes an analog-to-digital converter (ADC) and a digital signal processor (DSP), the ADC having an ADC input and an ADC output, the DSP having a DSP input and a DSP output, the ADC input coupled to the audio input, the DSP input coupled to the ADC output, and the DSP output coupled to the audio output; and wherein at least one of the ADC or the DSP has the wakeup input.

Example 7 is an acoustic device of any example herein, particularly example 1, wherein the acoustic sensor includes a piezoelectric cantilever or a capacitive sensor.

Example 8 is an acoustic device of any example herein, particularly example 1, wherein the acoustic sensor includes a plurality of sensor units, a plurality of sensor unit outputs, and a plurality of sensor unit inputs, wherein each plurality of sensor units having a sensor unit output, the plurality of sensor unit outputs being part of the sensor output, wherein the sensor input includes the plurality of sensor unit inputs, and wherein each sensor unit input of the plurality of sensor unit inputs is coupled to a respective one of the plurality of sensor unit outputs.

Example 9 is an acoustic device of any example herein, particularly example 8, wherein the plurality of sensor units includes a first sensor unit having a first resonant frequency, and a second sensor unit having a second resonant frequency, and wherein the first resonant frequency is different from the second resonant frequency.

Example 10 is an acoustic device of any example herein, particularly example 8, wherein the plurality of sensor units includes: a first sensor unit having a first sensor surface having a first dimension; and a second sensor unit having a second sensor surface having a second dimension different from the first dimension.

Example 11 is an acoustic device of any example herein, particularly example 8, wherein the plurality of sensor units includes: a first sensor unit having a first piezoelectric bimorph flap having a first bimorph structure; and a second sensor unit having a second piezoelectric bimorph flap having a second bimorph structure different from the first bimorph structure.

Example 12 is an acoustic device of any example herein, particularly example 8, wherein the wakeup signal generation circuit includes a weight and summation circuitry having a plurality of weighing inputs and a summation output, each of the plurality of weighing inputs coupled to a respective one of the plurality of sensor unit outputs, and the summation output is coupled to the wakeup output.

Example 13 is an acoustic device of any example herein, particularly example 1, wherein the audio system and the acoustic sensor have different frequency responses.

Example 14 is an acoustic device of any example herein, particularly example 13, wherein the audio system has a first sensitivity within a frequency range, wherein the acoustic sensor has a second sensitivity within the frequency range, and wherein the second sensitivity is higher than the first sensitivity.

Example 15 is an acoustic device of any example herein, particularly example 14, wherein the microphone has a first resonant frequency, wherein the acoustic sensor has a second resonant frequency, and wherein the second resonant frequency is lower than the first resonant frequency.

Example 16 is an acoustic device of any example herein, particularly example 15, wherein the second resonant frequency is within the frequency range.

Example 17 is an acoustic device of any example herein, particularly example 15, wherein the second resonant frequency is below 4 kHz.

Example 18 is an acoustic device of any example herein, particularly example 2, wherein the acoustic sensor has a control input, wherein the wakeup circuit has a control output coupled to the control input, and wherein the wakeup circuit is configured to provide a disable signal at the control output, after the wakeup output is set to the second state.

Example 19 is an acoustic device of any example herein, particularly example 18, wherein the acoustic sensor has a sensor surface, and wherein the acoustic sensor is configured to clamp the sensor surface at a particular position responsive to the disable signal.

Example 20 is an acoustic device of any example herein, particularly example 1, further comprising a first audio port and a second audio port, wherein the microphone is coupled to the first audio port, and wherein the acoustic sensor is coupled to the second audio port.

Example 21 is an acoustic device of any example herein, particularly example 1, wherein the microphone and the acoustic sensor are on a same die.

Example 22 is an acoustic device of any example herein, particularly example 1, further comprising a case that encloses the microphone, the acoustic sensor, and a back volume space that surrounds the microphone and the acoustic sensor.

Example 23 is a method comprising receiving an acoustic signal by an acoustic sensor separate from a microphone; generating a wakeup signal for an audio system including the microphone and a processing circuit based on at least one of an amplitude or a frequency of the acoustic signal; and providing the wakeup signal to the audio system to cause the processing circuit to transition from a first mode to a second mode.

Example 24 is a method of any example herein, particularly example 1, including disabling the processing circuit in the first mode.

Example 25 is a method of any example herein, particularly example 1, including: in the first mode, sampling an audio signal from the microphone at a first rate; and in the second mode, sampling the audio signal from the microphone at a second rate, wherein the first rate is lower than the second rate.

Example 26 is an apparatus comprising: an acoustic sensor having a sensor output, the acoustic sensor having a resonant frequency at or below 4 kHz; and a wakeup circuit having a sensor input and a wakeup output, the sensor input coupled to the sensor output.

Example 27 is an apparatus of any example herein, particularly example 26, wherein the acoustic sensor includes a piezoelectric cantilever or a capacitive sensor.

Example 28 is an apparatus of any example herein, particularly example 26, wherein the acoustic sensor includes a plurality of sensor units, a plurality of sensor unit outputs, and a plurality of sensor unit inputs, wherein each plurality of sensor units having a sensor unit output, the plurality of sensor unit outputs being part of the sensor output, wherein the sensor input includes the plurality of sensor unit inputs, and wherein each sensor unit input of the plurality of sensor unit inputs is coupled to a respective one of the plurality of sensor unit outputs.

Example 29 is an apparatus of any example herein, particularly example 28, wherein the plurality of sensor units includes a first sensor unit having a first resonant frequency, and a second sensor unit having a second resonant frequency, and wherein the first resonant frequency is different from the second resonant frequency.

Example 30 is an apparatus of any example herein, particularly example 28, wherein the plurality of sensor units includes: a first sensor unit having a first sensor surface having a first dimension; and a second sensor unit having a second sensor surface having a second dimension different from the first dimension.

Example 31 is an apparatus of any example herein, particularly example 28, wherein the plurality of sensor units includes: a first sensor unit having a first piezoelectric bimorph flap having a first bimorph structure; and a second sensor unit having a second piezoelectric bimorph flap having a second bimorph structure different from the first bimorph structure.

Example 32 is an apparatus of any example herein, particularly example 28, wherein the wakeup circuit includes a weight and summation circuitry having a plurality of weighing inputs and a summation output, each of the plurality of weighing inputs coupled to a respective one of the plurality of sensor unit outputs, and the summation output is coupled to the wakeup output.

Example 33 is an apparatus of any example herein, particularly example 26, wherein the wakeup circuit is coupled to an audio system, wherein the audio system and the acoustic sensor have different frequency responses.

Example 34 is an apparatus of any example herein, particularly example 26, wherein the audio system has a first sensitivity within a frequency range, wherein the acoustic sensor has a second sensitivity within the frequency range, and wherein the second sensitivity is higher than the first sensitivity.

Example 35 is an apparatus of any example herein, particularly example 34, wherein the audio system includes a microphone that has a first resonant frequency, wherein the acoustic sensor has a second resonant frequency, and wherein the second resonant frequency is lower than the first resonant frequency.

Example 36 is an apparatus of any example herein, particularly example 35, wherein the second resonant frequency is within the frequency range.

Example 37 is an apparatus comprising a circuitry having a wakeup output for a microphone based at least on detection of an audio by an acoustic sensor, wherein the acoustic sensor comprises a piezoelectric cantilever having a resonant frequency at or below 4 KHz.

Example 38 is an apparatus of any example herein, particularly example 37, wherein the circuitry, the microphone, and the acoustic sensor are under a package.

Example 39 is method comprising: receiving a first audio of a first frequency; generating a wakeup indication for a microphone based on detection of the first audio by an acoustic sensor; and waking up the microphone based on the wakeup indication, wherein the acoustic sensor comprises a piezoelectric cantilever having a resonant frequency at or below 4 KHz.

Example 40 is a method of any example herein, particularly example 39, further comprising: clamping a portion of the acoustic sensor after waking up the microphone; receiving a second audio by the microphone, the second audio having a second frequency; and processing the second audio, wherein the first frequency is different than the second frequency.

Example 41 is an acoustic transducer device comprising: a microphone to detect a first audio; a sensor to detect a second audio; and a circuitry coupled to the microphone and the sensor, wherein the circuitry is operable to generate a wakeup indication for the microphone based on detection of the second audio by the sensor.

Example 42 is an acoustic transducer device of any example herein, particularly example 41, wherein the first audio is in a first frequency band, wherein the second audio is in a second frequency band, and wherein the second frequency band is narrower than the first frequency band.

Example 43 is an acoustic transducer device of any example herein, particularly example 42, wherein the microphone has a first resonant frequency, wherein the sensor has a second resonant frequency, wherein the second resonant frequency is lower than the first resonant frequency.

Example 44 is an acoustic transducer device of any example herein, particularly example 43, wherein the second resonant frequency is below 4 Khz.

Example 45 is an acoustic transducer device of any example herein, particularly example 43, wherein the sensor comprises a plurality of sensor units, and wherein an individual sensor unit is coupled to the circuitry.

Example 46 is an acoustic transducer device of any example herein, particularly example 45, wherein the individual sensor unit comprises a piezoelectric cantilever or a capacitive sensor.

Example 47 is an acoustic transducer device of any example herein, particularly example 41, wherein the circuitry is configured to clamp the sensor to a predetermined position based on generation of the wakeup indication for the microphone.

Example 48 is an acoustic transducer device of any example herein, particularly example 41, wherein the sensor comprises a piezoelectric cantilever, wherein the acoustic transducer device further comprising a structure, and wherein the sensor is configured to rest on the structure based on the sensor being disabled.

Example 49 is an acoustic transducer device of any example herein, particularly example 41, wherein the microphone and the sensor share a back volume.

Example 50 is an acoustic transducer device of any example herein, particularly example 41, wherein the microphone and the sensor are on a same die.

Example 51 is an acoustic transducer device of any example herein, particularly example 41, wherein the microphone and the sensor are on different dies.

Besides what is described herein, various modifications can be made to disclose implementations and implementations thereof without departing from their scope. Therefore, illustrations of implementations herein should be construed as examples, and not restrictive to scope of present disclosure.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

What is claimed is:

1. An acoustic device comprising:
an audio system including: a microphone having a microphone output, and a processing circuit having a wakeup input, an audio input, and an audio output, the audio input coupled to the microphone output;
an acoustic sensor separate from the microphone, the acoustic sensor having a sensor output; and
a wakeup circuit having a sensor input and a wakeup output, the sensor input coupled to the sensor output, and the wakeup output coupled to the wakeup input.

2. The acoustic device of claim 1, wherein the processing circuit is configured to enter a first mode responsive to the wakeup input in a first state, and to enter a second mode responsive to the wakeup input in a second state.

3. The acoustic device of claim 2, wherein the processing circuit is disabled in the first mode.

4. The acoustic device of claim 2, wherein the processing circuit is configured to:
in the first mode, sample an audio signal at the audio input at a first rate; and
in the second mode, sample the audio signal at the audio input at a second rate, in which the first rate is lower than the second rate.

5. The acoustic device of claim 1, wherein the wakeup circuit includes a comparator having a first comparator input, a reference input, and a comparator output, the first comparator input coupled to the sensor input, and the comparator output coupled to the wakeup output.

6. The acoustic device of claim 1, wherein the processing circuit includes an analog-to-digital converter (ADC) and a digital signal processor (DSP), the ADC having an ADC input and an ADC output, the DSP having a DSP input and a DSP output, the ADC input coupled to the audio input, the DSP input coupled to the ADC output, and the DSP output coupled to the audio output; and wherein at least one of the ADC or the DSP has the wakeup input.

7. The acoustic device of claim 1, wherein the acoustic sensor includes a piezoelectric cantilever or a capacitive sensor.

8. The acoustic device of claim 1, wherein the acoustic sensor includes a plurality of sensor units, a plurality of sensor unit outputs, and a plurality of sensor unit inputs, wherein each plurality of sensor units having a sensor unit output, the plurality of sensor unit outputs being part of the sensor output, wherein the sensor input includes the plurality of sensor unit inputs, and wherein each sensor unit input of the plurality of sensor unit inputs is coupled to a respective one of the plurality of sensor unit outputs.

9. The acoustic device of claim 8, wherein the plurality of sensor units includes a first sensor unit having a first resonant frequency, and a second sensor unit having a second resonant frequency, and wherein the first resonant frequency is different from the second resonant frequency.

10. The acoustic device of claim 8, wherein the plurality of sensor units includes:
a first sensor unit having a first sensor surface having a first dimension; and
a second sensor unit having a second sensor surface having a second dimension different from the first dimension.

11. The acoustic device of claim 8, wherein the plurality of sensor units includes:
a first sensor unit having a first piezoelectric bimorph flap having a first bimorph structure; and
a second sensor unit having a second piezoelectric bimorph flap having a second bimorph structure different from the first bimorph structure.

12. The acoustic device of claim 8, wherein the wakeup circuit includes a weight and summation circuitry having a plurality of weighing inputs and a summation output, each of the plurality of weighing inputs coupled to a respective one of the plurality of sensor unit outputs, and the summation output is coupled to the wakeup output.

13. The acoustic device of claim 1, wherein the audio system and the acoustic sensor have different frequency responses.

14. The acoustic device of claim 13, wherein the audio system has a first sensitivity within a frequency range, wherein the acoustic sensor has a second sensitivity within the frequency range, and wherein the second sensitivity is higher than the first sensitivity.

15. The acoustic device of claim 14, wherein the microphone has a first resonant frequency, wherein the acoustic sensor has a second resonant frequency, and wherein the second resonant frequency is lower than the first resonant frequency.

16. The acoustic device of claim 15, wherein the second resonant frequency is within the frequency range.

17. The acoustic device of claim 15, wherein the second resonant frequency is below 4 kHz.

18. The acoustic device of claim 2, wherein the acoustic sensor has a control input, wherein the wakeup circuit has a control output coupled to the control input, and wherein the wakeup circuit is configured to provide a disable signal at the control output, after the wakeup output is set to the second state.

19. The acoustic device of claim 18, wherein the acoustic sensor has a sensor surface, and wherein the acoustic sensor is configured to clamp the sensor surface at a particular position responsive to the disable signal.

20. The acoustic device of claim 1, further comprising a first audio port and a second audio port, wherein the microphone is coupled to the first audio port, and wherein the acoustic sensor is coupled to the second audio port.

21. The acoustic device of claim 1, wherein the microphone and the acoustic sensor are on a same die.

22. The acoustic device of claim 1, further comprising a case that encloses the microphone, the acoustic sensor, and a back volume space that surrounds the microphone and the acoustic sensor.

23. An apparatus comprising:
an acoustic sensor having a sensor output, the acoustic sensor having a resonant frequency at or below 4 kHz; and
a wakeup circuit having a sensor input and a wakeup output, the sensor input coupled to the sensor output.

24. The apparatus of claim 23, wherein the acoustic sensor includes a piezoelectric cantilever or a capacitive sensor.

25. A method comprising:
receiving an acoustic signal by an acoustic sensor separate from a microphone;
generating a wakeup signal for an audio system including the microphone and a processing circuit based on at least one of an amplitude or a frequency of the acoustic signal; and
providing the wakeup signal to the audio system to cause the processing circuit to transition from a first mode to a second mode.

26. The method of claim 25 including disabling the processing circuit in the first mode.

27. The method of claim 25 including:
in the first mode, sampling an audio signal from the microphone at a first rate; and
in the second mode, sampling the audio signal from the microphone at a second rate, wherein the first rate is lower than the second rate.
